(19) United States
(12) Patent Application Publication
(10) Pub. No.: US 2017/0068311 A1
(43) Pub. Date: Mar. 9, 2017

(54) SYSTEM, APPARATUS, AND METHOD FOR SELECTIVELY VARYING THE IMMERSION OF A MEDIA EXPERIENCE

(71) Applicant: Avegant Corp., Belmont, CA (US)

(72) Inventors: Allan Thomas Evans, Redwood City, CA (US); Andrew Gross, Redwood City, CA (US)

(21) Appl. No.: 14/678,974

(22) Filed: Apr. 4, 2015

(51) Int. Cl. G06F 3/01; G09G 5/00; G06F 3/16

(52) U.S. Cl. CPC G06F 3/011; G06F 3/013; G06F 3/167; G06F 3/017; G09G 5/003; G09G 2354/00

(57) ABSTRACT

An apparatus (110), system (100), and method (900) for enabling a user (90) to engage in a media experience (840) while the immersive nature of that experience is selectively varied. Purposeful user actions (760) as well as environmental stimuli (780) can serve as triggers (750) for changes in the operating configuration (705) of the apparatus (110). Operating configurations (705) pertain to operating parameters (700) that can relate to the sound (710), display (720), progression (730), and haptic (740) parameters of the media experience (840) as conveyed through the apparatus (110).

### BACKGROUND OF THE INVENTION

The invention is an apparatus, system, and method that can provide a user with a media experience (collectively the “system”). More specifically, the system can enable a user to engage in a media experience while selectively varying the immersive nature of that experience.

Some people use media devices as part of their jobs. Others use media devices for recreation and distraction. Whatever the purpose in engaging in a media experience, it can be an extremely immersive experience. Be it viewing a movie, listening to music, playing a video game, engaging in a simulated world of virtual reality, reading a great e-book, or creating creative content yourself, engaging in a media experience can be an extremely immersive experience. Great media content can draw us in to all sorts of fictional worlds. It is easy to lose track of time when the media content is merely mediocre.

The potentially immersive nature of a media experience is particularly powerful in the context of personal media devices where there is only one user. Whether the device is a small smartphone screen or virtual retina display visor capable of blocking the outside world from view, such devices can serve as powerful tools for play, education, entertainment, relaxation, and productive activities.

There are times in a media experience where a user can is needlessly interrupted. There are also times when engaging in a media experience that the user wants to be interrupted in as efficient manner as possible. It would be helpful for users if media devices were better at enabling a user to quickly traverse in and out of a media experience in addressing concerns pertaining the real world, such as the physical environment of the user.

The inefficiencies in the prior art are particularly pronounced when dealing with highly immersive media devices such as head-mounted displays. Any head-mounted display capable of displaying an artificially created image in front of the user is a device that is also capable of blocking the user's view of the physical environment. Any device capable of delivering sound to the ears of a user is going to be capable of crowding out other sounds that the user may need to hear.

Prior art solutions for managing interruptions in the media experience of many personal media devices such as head-mounted displays is for the user to turn off the device, remove the device from their head, take care of the interruption, put the device back on their head, and restart the media. This can be needlessly time consuming. Moreover, a desire to avoid needlessly time consuming distractions or interruptions may result in the individual missing interruptions that they would not want to miss.

It would be desirable if media devices assisted users in transitioning between the real world and the media experience in a less time consuming manner by giving the user options between a 100% immersive media experience and the media experience being stopped altogether.

### SUMMARY OF THE INVENTION

The invention is an apparatus, system, and method that can provide a user with a media experience (collectively the “system”). More specifically, the system can enable a user to engage in a media experience while selectively varying the immersive nature of that experience.

The system makes it easier for users to go and forth between the real world and the media experience that they are engaging in. The system can provide a variety of options between a fully immersed experience, and a media experience that has been turned off. The system can also apply some intelligence in terms of when a user is interrupted, and how that user is interrupted.

### BRIEF DESCRIPTION OF THE DRAWINGS

Many features and inventive aspects of the system are illustrated in the various drawings described briefly below. However, no patent application can expressly disclose in words or in drawings, all of the potential embodiments of an invention. Variations of known equivalents are implicitly included. In accordance with the provisions of the patent statutes, the principles, functions, and modes of operation of the systems, apparatuses, and methods (collectively the “system”) are explained and illustrated in certain preferred embodiments. However, it must be understood that the inventive systems may be practiced otherwise than is specifically explained and illustrated without departing from its spirit or scope. All components illustrated in the drawings below and associated with element numbers are named and described in Table 1 provided in the Detailed Description section.

FIG. 1a is a block diagram illustrating the different aspects of interaction that occur within the system.

FIG. 1b is an input-output diagram illustrating how different triggers can prompt the system to adopt different configurations of different parameters.

FIG. 1c is a composition diagram illustrating an example of some of the different types of user action triggers that the system can be cognizant of.

FIG. 1d is a composition diagram illustrating an example of some of the different types of environmental stimuli triggers that the system can be cognizant of.

FIG. 1e is a composition diagram illustrating an example of different types of sound parameters that can be incorporated into different configurations of the system.

FIG. 1f is a composition diagram illustrating an example of different types of display parameters that can be incorporated into different configurations of the system.

FIG. 1g is a composition diagram illustrating an example of different types of progression parameters that can be incorporated into different configurations of the system.

FIG. 1h is a composition diagram illustrating an example of different types of haptic parameters that can be incorporated into different configurations of the system.

FIG. 1i is a flow chart diagram illustrating an example of the process flow of the system.

FIG. 1j is a block diagram illustrating an example of how a partially transparent plate and a curved mirror can be used to direct light from (1) the imaging assembly to the eye of a viewer, (2) the eye of the viewer to a tracking assembly, and (3) from the exterior environment to the eye of the user.

FIG. 2a is a block diagram illustrating an example of different assemblies, components, and light that can be present in the operation of the system.

FIG. 2b is a block diagram similar to FIG. 2a, except that the disclosed system also includes a tracking assembly.

FIG. 2b is a block diagram similar to FIG. 2a, except that the disclosed system also includes a tracking assembly.

FIG. 2c is a block diagram similar to FIG. 2a, except that the disclosed system also includes an augmentation assembly.

FIG. 2d is a block diagram similar to FIG. 2a, except that the disclosed system also includes an augmentation assembly and a tracking assembly.

FIG. 2e is a hierarchy diagram illustrating an example of different components that can be included in an illumination assembly.

FIG. 2f is a hierarchy diagram illustrating an example of different components that can be included in an imaging assembly.

FIG. 2g is a hierarchy diagram illustrating an example of different components that can be included in a projection assembly.

FIG. 2h is a hierarchy diagram illustrating an example of different components that can be included in the sensor assembly.

FIG. 2i is a hierarchy diagram illustrating an example of different components that can be included in the tuning assembly.

FIG. 2j is hierarchy diagram illustrating examples of different types of supporting components that can be included in the structure and function of the system.

FIG. 2k is a block diagram illustrating an example of a system configuration that includes a curved mirror and a partially transparent plate.

FIG. 2l is a flow chart illustrating an example of core steps in displaying an image.

FIG. 3a is a block diagram illustrating an example of a DLP system that uses a tuning assembly after light is modulated into an interim image.

FIG. 3b is a block diagram illustrating a more detailed example of a DLP system.

FIG. 3c is a block diagram illustrating an example of a LCOS system that uses a tuning assembly.

FIG. 4a is diagram of a perspective view of a VRD apparatus embodiment of the system.

FIG. 4b is environmental diagram illustrating an example of a side view of a user wearing a VRD apparatus embodying the system.

FIG. 4c is a configuration diagram illustrating an example of the components that can be used in a VRD apparatus.

FIG. 5a is a hierarchy diagram illustrating an example of the different categories of display systems that the innovative system can be potentially be implemented in, ranging from giant systems such as stadium scoreboards to VRD visor systems that project visual images directly on the retina of an individual user.

FIG. 5b is a hierarchy diagram illustrating an example of different categories of display apparatuses that close mirrors the systems of FIG. 5a.

FIG. 5c is a perspective view diagram illustrating an example of user wearing a VRD visor apparatus.

FIG. 5d is hierarchy diagram illustrating an example of different display/projection technologies that can be incorporated into the system, such as DLP-based applications.

FIG. 5e is a hierarchy diagram illustrating an example of different operating modes of the system pertaining to immersion and augmentation.

FIG. 5f is a hierarchy diagram illustrating an example of different operating modes of the system pertaining to the use of sensors to detect attributes of the user and/or the user's use of the system.

FIG. 5g is a hierarchy diagram illustrating an example of different categories of system implementation based on whether or not the device(s) are integrated with media player components.

FIG. 5h is hierarchy diagram illustrating an example of two roles or types of users, a viewer of an image and an operator of the system.

FIG. 5i is a hierarchy diagram illustrating an example of different attributes that can be associated with media content.

FIG. 5j is a hierarchy diagram illustrating examples of different contexts of images.

### DETAILED DESCRIPTION

The invention is an apparatus, system, and method that can provide a user with a media experience (collectively the “system”). More specifically, the system can enable a user to engage in a media experience while selectively varying the immersive nature of that experience.

### I. OVERVIEW

An effective media experience can be highly immersive. Whether the purpose of the media experience is work, pleasure, or a combination of both, it can be relatively easy to lose oneself in a media experience. The more immersive the experience, the more annoying it can be to change back and forth between interacting with the real world and interacting with the media experience. The system can assist users in making this transition in a variety of different ways.

First, the system can provide non-binary options between the normal immersive media experience and a media experience that has been turned off. The media experience can be paused instead of stopped. Sound levels can be reduced, or sound can be muted. Displayed images can be dimmed. Immersion-based display systems can transform themselves into augmentation-based display systems while the user is interacting with the outside world. Head mounted media access devices with exterior cameras and microphones can temporarily pipe in visual and sound content from the exterior environment instead of the media content playing on the system.

Second, for those contexts where the user may desire (or safety considerations require) an all or nothing media experiences, the system can allow the user to interact with the physical world without need to taking of the device, turn it off, stop the media experience etc. For example, the system can be configured to transition between a full immersion operating mode into a full transparency operating mode where the visual display becomes transparent or can be moved away from the eyes of the user while the media content is paused. Similarly, headphone components can be moved away while the media content is merely paused. Alternatively, the system can use external cameras, external microphones, and other sensors to “pipe in” data from the operating environment. This approach transforms the physical environment of the user into a real time media m the only sound, visual, and or attributes being communicated to the user originate from the exterior environment and not the media content.

Third, the system can itself assist the user in being interrupted when the user wants to be interrupted, and conversely, not interrupting the user when the user would not value the interruption. For example, phone calls and other communications could be routed through a head-mounted media player. The device could differentiate between and a call from a close family member would merit an interruption, and a call from a telemarketer which would not. The device could be configured to automatically pause the media experience for some callers, merely provide a small scrolling notification at the bottom of a screen for other callers, while fully ignoring other calls. A similar approach can be utilized for other forms of communication such as e-mail, text messages, etc. Such an approach can also be applied more broadly to other potential triggers. A person not wanting lose track of time may implement an alarm using the system such that the media experience automatically stops at a particular time. A parent of a young child may want the device to automatically pause the media experience if the device hears the sound of a baby waking up, crying, etc. A person travelling on a train may want the device to interrupt the media experience when a GPS capability in the device determines that the user is about to reach their destination. In addressing all of these interruptions, some wanted and some not, the system can selectively modify the extent to which the media experience is immersive to the user such that the user can effectively deal with those interruptions. In some embodiments of the system, the user can modify any trigger relating to any change of operating configuration. In other embodiments, some limits can be placed on this flexibility.

Fourth, some embodiments of the system can be used to facilitate communications with the outside world. For example, an elderly parent using a VRD visor apparatus to watch movies could have the device communicate with various healthcare monitoring devices on or near the user. The VRD visor apparatus could be configured to make appropriate use of the data, and even to initiate emergency communications if something serious is detected.

A. Apparatus

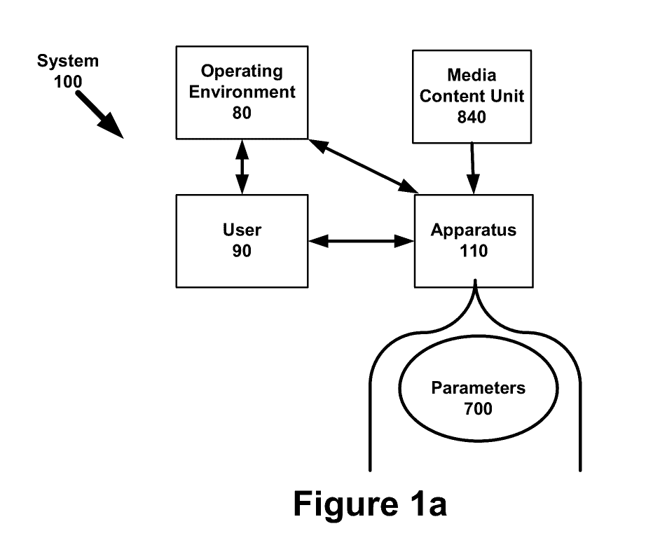

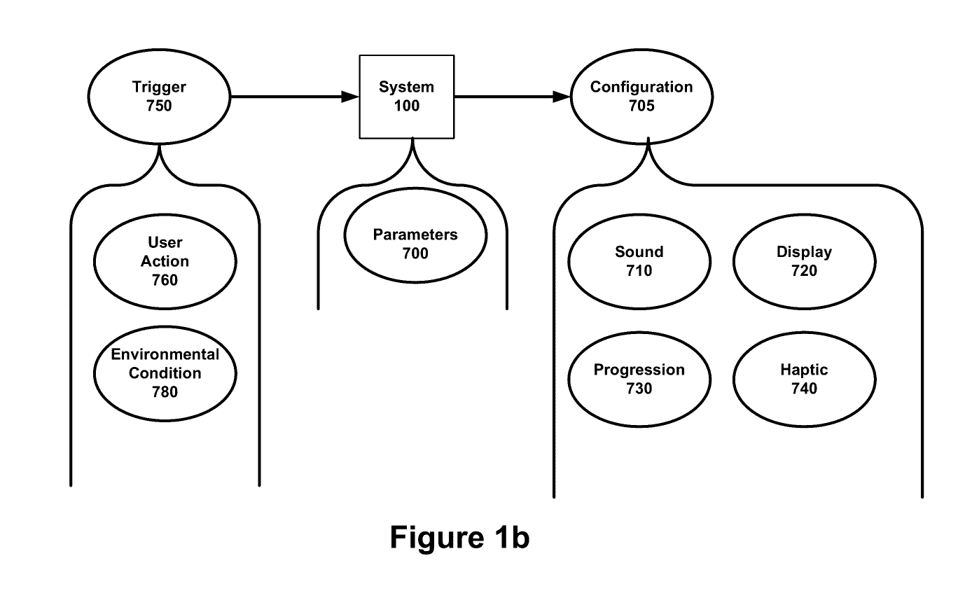

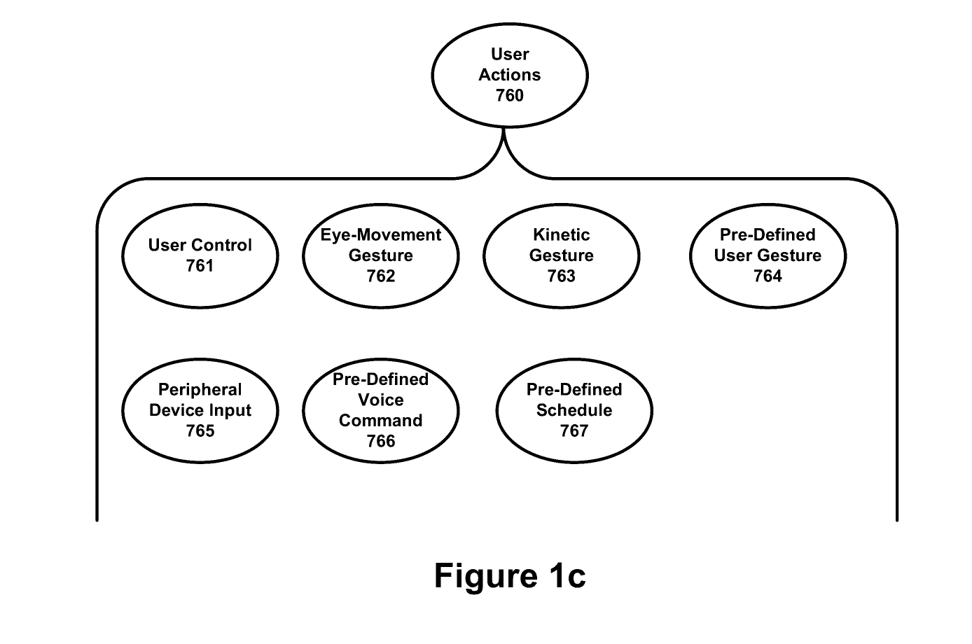

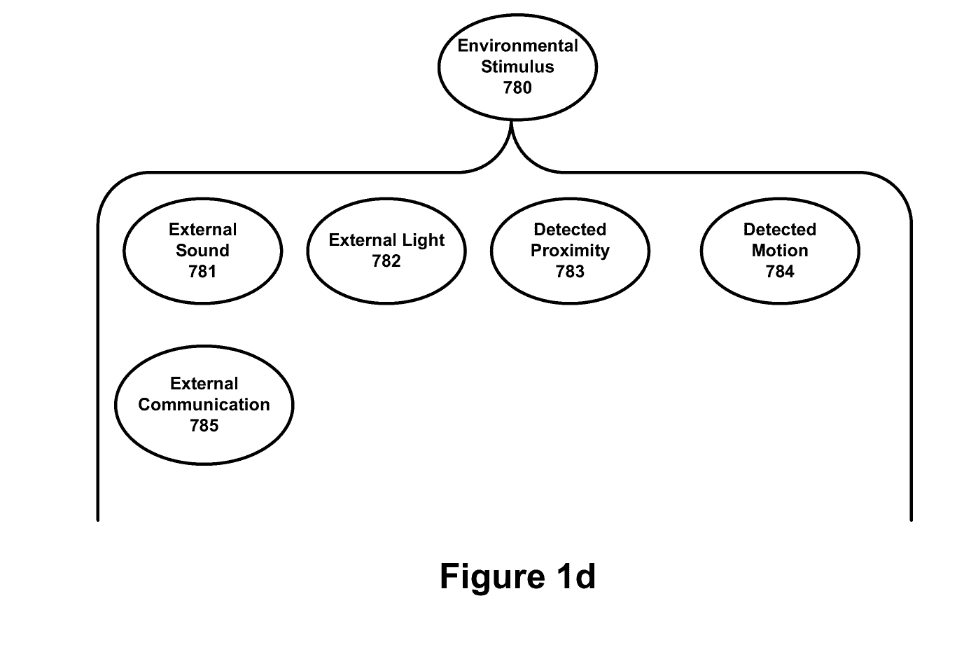

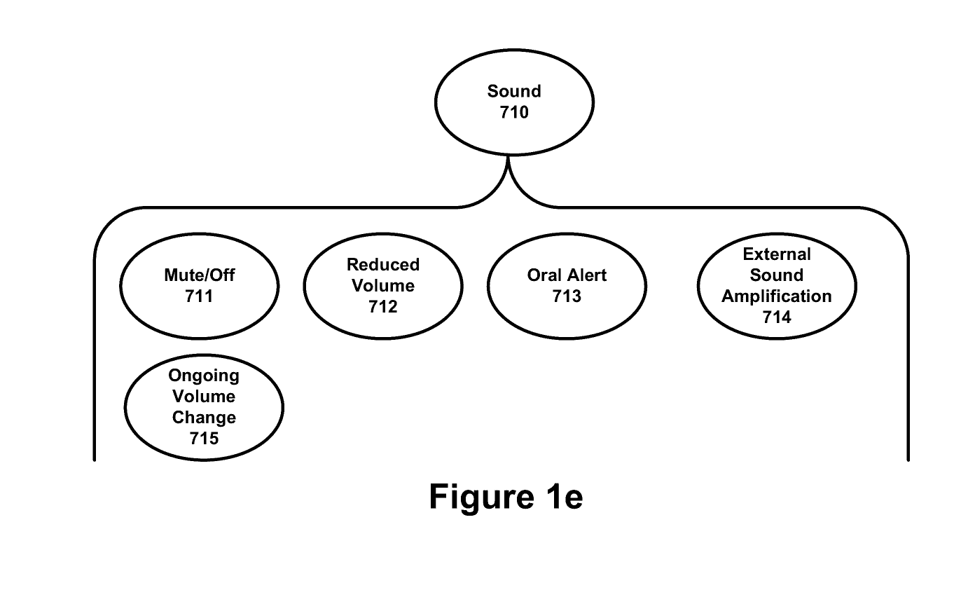

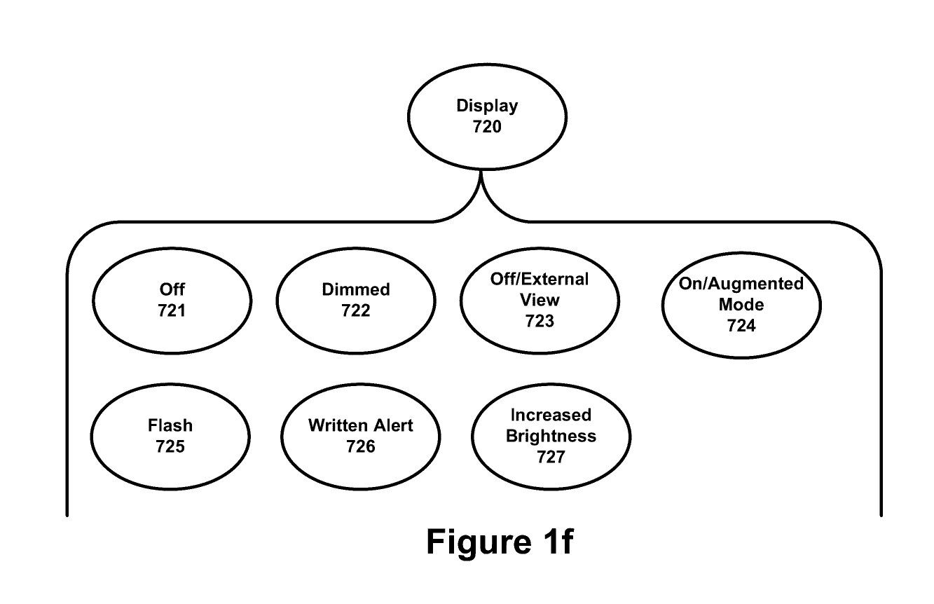

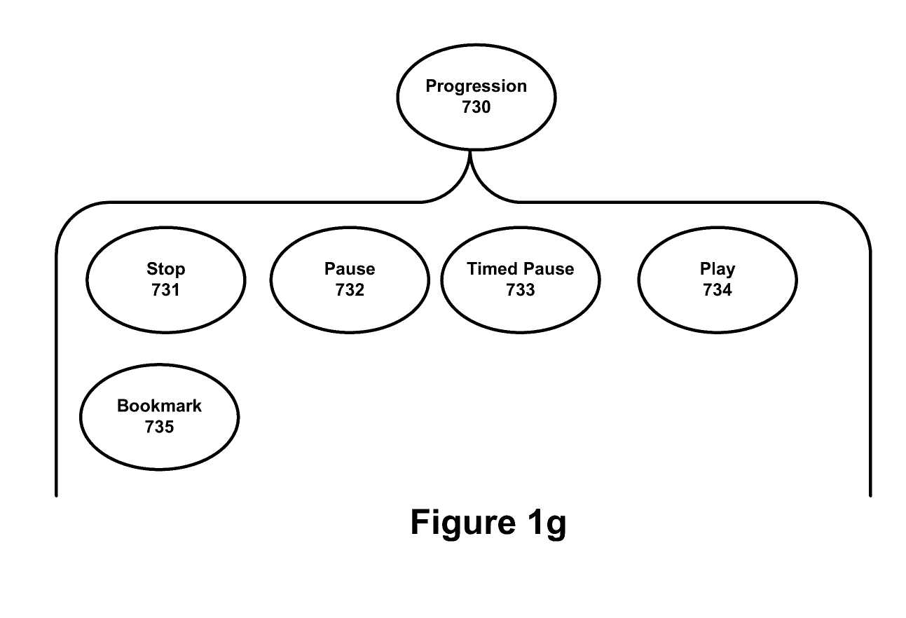

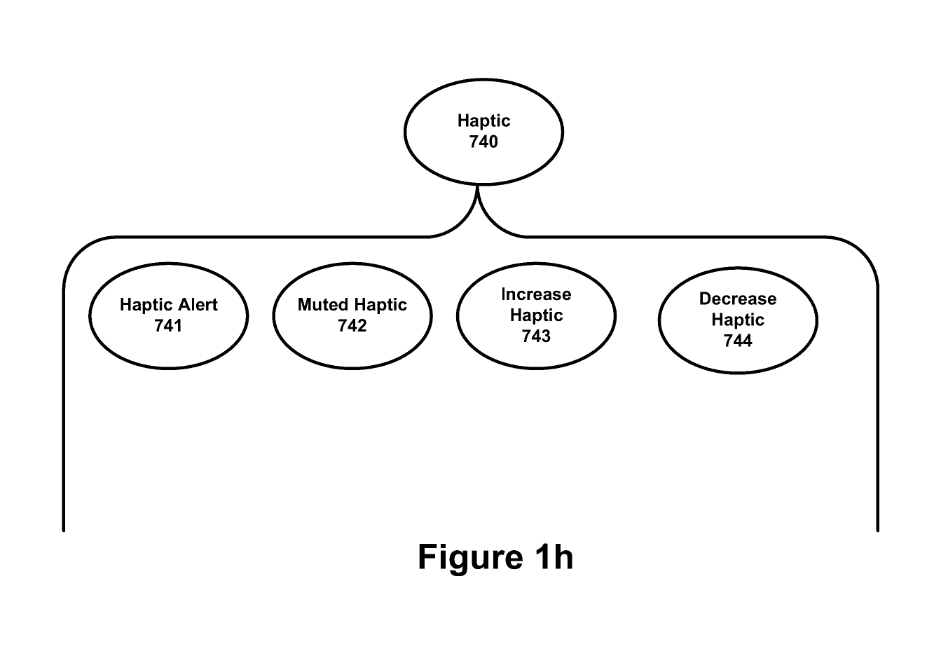

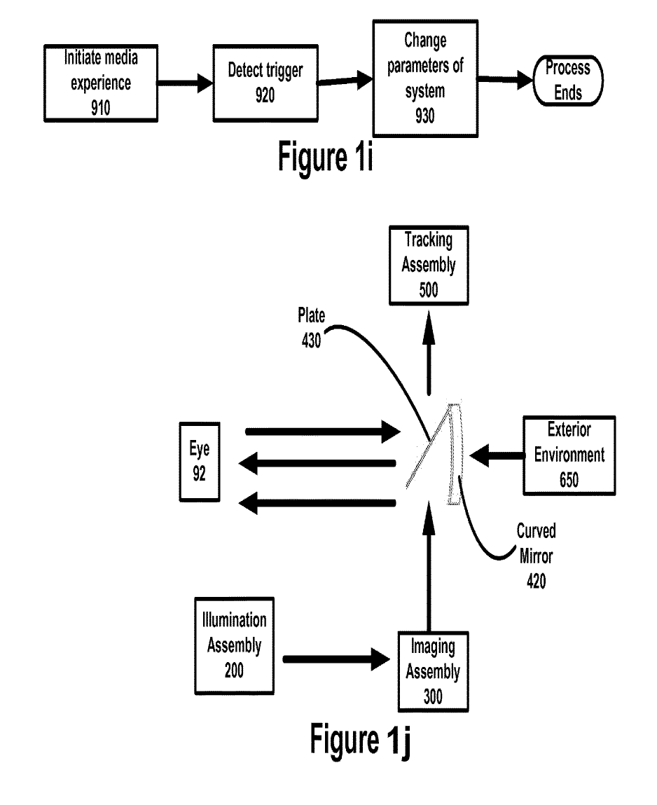

FIG. 1a is a block diagram illustrating the different aspects of interaction that occur within a system 100. The system 100 will include an apparatus 110 through which the user 90 interacts with a media content unit 840 (which can also be referred to as a media experience 840). The apparatus 110 can be a fully integrated media playing device such as smart phone, or merely the part of the communication chain that is in direct contact with a user 90, such as a pair of headphones. Different embodiments of the system 100 can involve different degrees of integration when it comes to the apparatuses 110 used to access the media experience 840. The apparatus 110 is a component of the system 100 that is capable of interacting directly with a user 90, an operating environment 80 in which the user 90 and apparatus 110 are present, and the media content unit 840.

Most apparatuses 110 will be able to communicate media experiences 840 to users 90 that include visual attributes 841 as well as acoustic attributes 842. In the future, touch, smell, and even taste are more likely to be included as part of media experiences 840. Conversely, some media experiences involve just one sense, such as listening to music or reading an e-book.

B. Parameters

The system 100 and its component devices such as the apparatus 110 can be configured using a wide variety of different parameters 700. Some parameters 700 are mutually exclusive of other parameters (the volume of sound cannot for example be both muted and increased at the same time). Other parameters 700 can coexist with each other (sound from the outside world can be piped in while the volume of sound from the media experience can be reduced or even fully muted). Each system 100 can be thought to have a universe of potential parameters 700 that can be used to temporarily or even permanently impact the operation of the system 100 in terms of how the media experience is made accessible to users 90.

FIG. 1b is an input-output diagram illustrating how different triggers 750 can prompt the system 100 to adopt different configurations 705 of different parameters 700. Each operating potential operating configuration 705 of the system 100 can be thought of as a selection or activation of certain potential operating parameters 700. The system 100 can thus link specific triggers 750 to specific operating configurations 705 that possess certain operating parameters 700.

FIG. 1b illustrates some of the high-level trigger categories that can be incorporated into the system 100 as well as some of the high-level parameter 700 categories that can be associated with specific configurations 705.

C. Triggers

FIG. 1b reveals two type of trigger 750 categories, a user action 750 and an environmental stimulus 780 (which can also be referred to as an environment stimulus 780).

1. User Actions

As illustrated in FIG. 1c, a user action 750 includes intentional actions by the user 90 such as: use/manipulation of a user control 761 such as a button, knob, dial, switch, etc.; an eye-movement gesture 762 that is tracked by a tracking assembly 500 in the apparatus 110; a kinetic gesture 763 registered with an inertial measurement unit (IMU) of the apparatus 110; a pre-defined user gesture 764 such as the clapping of hands or the moving of legs that are detected by sensors 510 of the system 100; peripheral device inputs 765 such as a separate keyboard, mouse, cell phone, external microphone, external motion tracker, etc.; a pre-defined voice command 766 captured by a microphone or similar sensor 510; and a pre-defined schedule 767, such as a day, time of day, or duration.

2. Environmental Conditions/Stimuli

FIG. 1d illustrates some examples of environmental conditions 780, which can also be referred to as environment stimuli 780. Examples of environmental stimuli 780 can include but are not limited to: an external sound 781 such as a baby crying, cognizable speech, or merely sound of a certain intensity; an external light 782, which can be distinguished on the basis of intensity, duration, wavelength, etc.; a detected proximity 783 of an object within the environment 80; a detected motion 784 within the environment 784; and an external communication 785 such as a phone call, e-mail, text message, video call, etc., that the apparatus 110 or system 100 is cognizant of.

D. Configurations

As illustrated in FIG. 1b, the system 100 can include a variety of different configurations 705, with different configurations 705 being triggered by different triggers 70 or even combinations of triggers 750. Each configuration 705 involves different combinations of operating parameters 700. Some configurations 705 may be very similar to other configurations 705 in that they differ maybe in only a single parameter 700. Other configurations 705 can involve more dramatic differences. In many embodiments of the system 100, the user 90 can have the ability to define their own configurations 705, modify template/default configurations 705, and link triggers 750 to configurations 705 and their applicable parameters 700. As illustrated in FIG. 1b, examples of high-level categories of parameters 700 that can be incorporated into various configurations 705 include but are not limited to sound parameters 710, display parameters 720, progression parameters 730, and haptic parameters 740.

1. Sound Parameters

The system 100 can incorporate a wide variety of different sound parameters 710 which impact the communication of acoustic attributes 842 to the user 90. Examples of such parameters 710 can include but are not limited to: a mute/off 711 where there is no sound communicated to the user 90; a reduced volume 712 where the magnitude of sound is temporarily reduced in response to a trigger 750 (different triggers 750 can involve different magnitudes of reduction); an oral alert 713 is a spoken message notifying the user 90 of something related to the trigger 750; an external sound amplification 714 is when the system 100 is trying to convey information to the user 90 about the outside environment 80; and an ongoing volume change 715 is a volume change that is not automatically undone at a specific period of time.

2. Display Parameters

The system 100 can incorporate a wide variety of different display parameters 720 which impact the communication of visual attributes 841 to the user 90. Examples of such parameters 720 can include but are not limited to: an off 721; a dimmed 722 display that involves a reduction of light intensity; an off/external view 723 where the media content 840 is no longer displayed and the system 100 instead allows the user to directly view the exterior environment 80 or uses an exterior camera to display an image of the exterior environment 80; an on/augmented mode 724 where the media content 840 continues to be displayed, but in an augmentation mode 122 where the visual attributes 841 of the media content 840 overlay an image of the exterior environment 80; a flash 725 of light as a form of an alert; a written alert 726 communicating some fact to the user 90 that relates to the trigger 750; and an increased brightness 727 which can also be an effective way to alert the user 90 of something occurring in the physical environment 80.

3. Progression Parameters

Progression parameters 730 relate to the playing of the media experience 840. Examples can include but are not limited to: a stop parameter 731; a pause parameter 732; a timed pause parameter 733 (different triggers 750 can result in pauses of different pre-defined length); a play parameter 734; and a bookmark parameter 735 that identifies where in the media experience 840 a user is when a certain trigger 750 occurs.

4. Haptic Parameters

Haptic 740 parameters pertain to haptic feedback which can be activated as an alert 741, dimmed/reduced/muted 742, increased haptic 743, and decreased haptic 744.

When a media experience 840 involves a substantial volume of noise and visually gripping images, haptic feedback can be an effective way to get the user's attention without simply shutting down the visual and/or acoustic content.

E. Process Flow View

FIG. 1i is a flow chart diagram illustrating an example of the process flow of the system 100.

At 910, the user 90 initiates a media experience 910. Before this is performed, some embodiments of the system 100 will allow the user 90 to create and/or customize triggers 750. In other embodiments, the triggers 750 are all preset and cannot be modified.

At 920, while the system 100 delivers a media experience 840 to the user 90, a trigger 750 is detected.

At 930, the system 100 changes operating configurations 705 in response to the trigger 750. In many instances, automated changes of configurations 705 will transition to configurations 705 that are less immersive than the prior configuration 705.

F. Sensors and Optics

The system 100 can include a wide variety of different sensors 510 for capturing information from the outside world as well as internal media components for bringing a desirable media experience 840 to the user 90. The greater the capabilities of these devices, the greater the diversity of potential triggers 750 and configurations 705. It can be challenging task to design a relatively small apparatus 110 that is capable of delivering high quality media content, tracking user eye movements, providing options for the display of augmented reality, and include sensors for capturing images, sounds, and other useful information from the exterior environment 80.

FIG. 1j is a block diagram illustrating an example of how a partially transparent plate and a curved mirror can be used to direct light from (1) the imaging assembly to the eye of a viewer, (2) the eye of the viewer to a tracking assembly, and (3) from the exterior environment to the eye of the user.

### II. ASSEMBLIES AND COMPONENTS

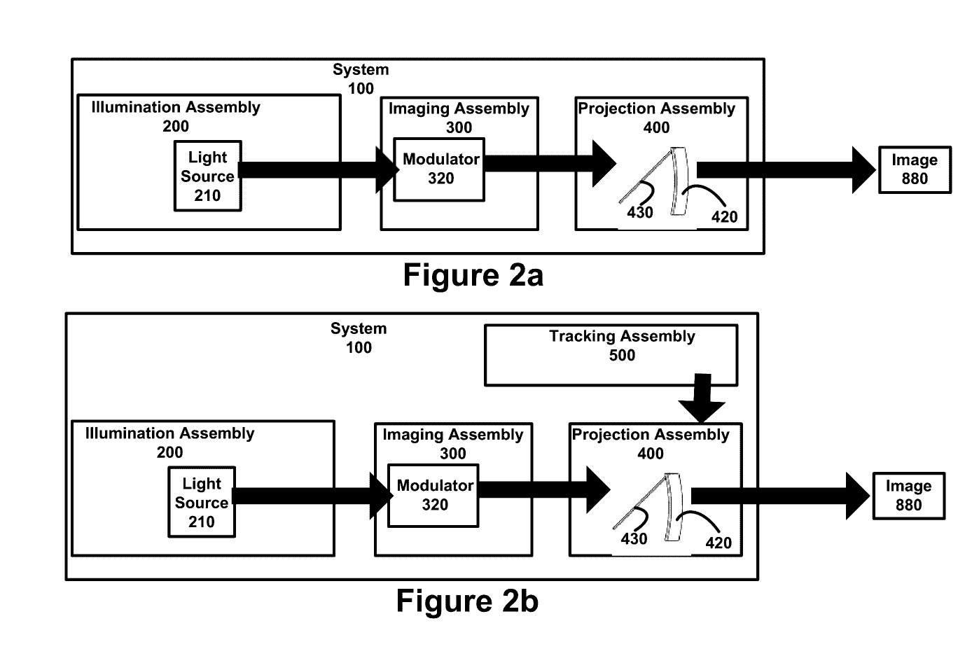

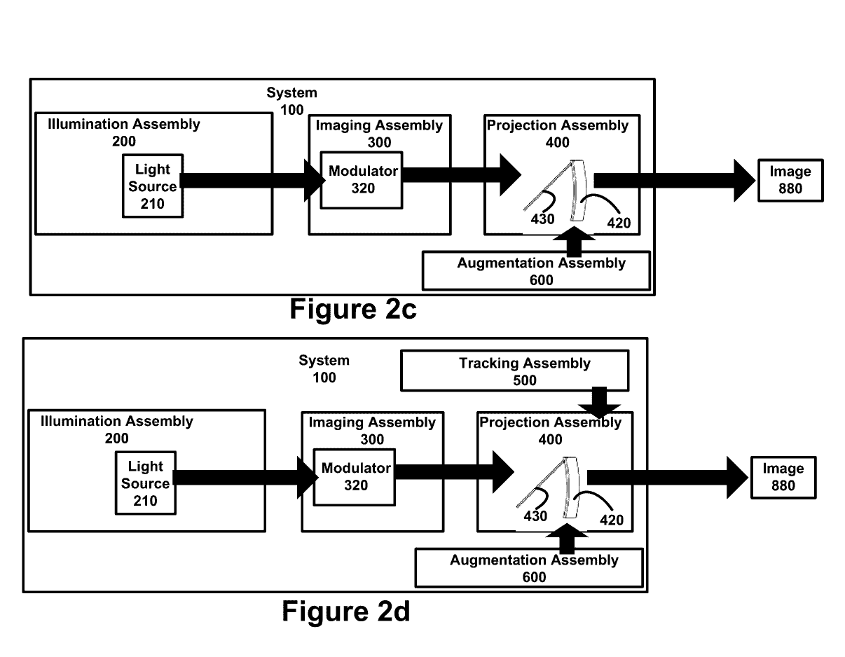

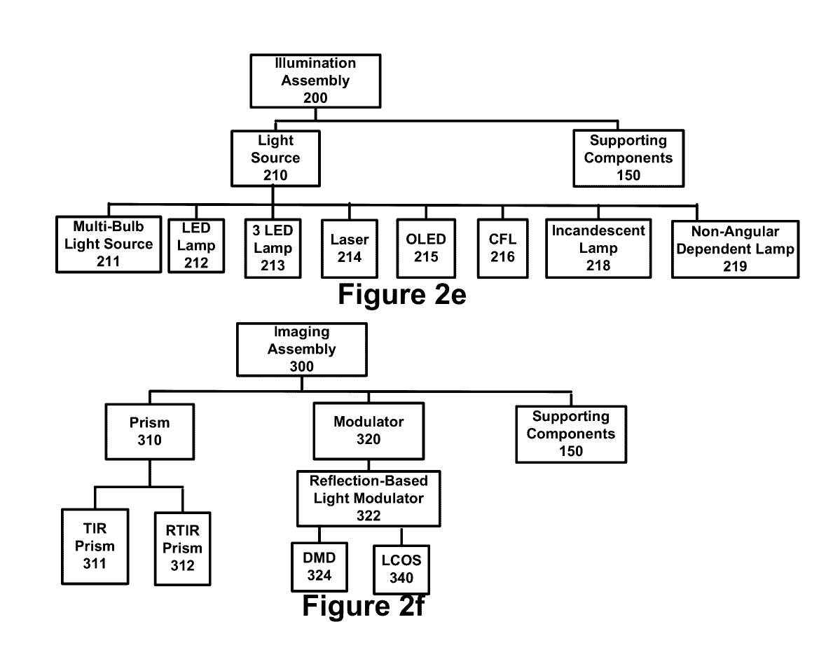

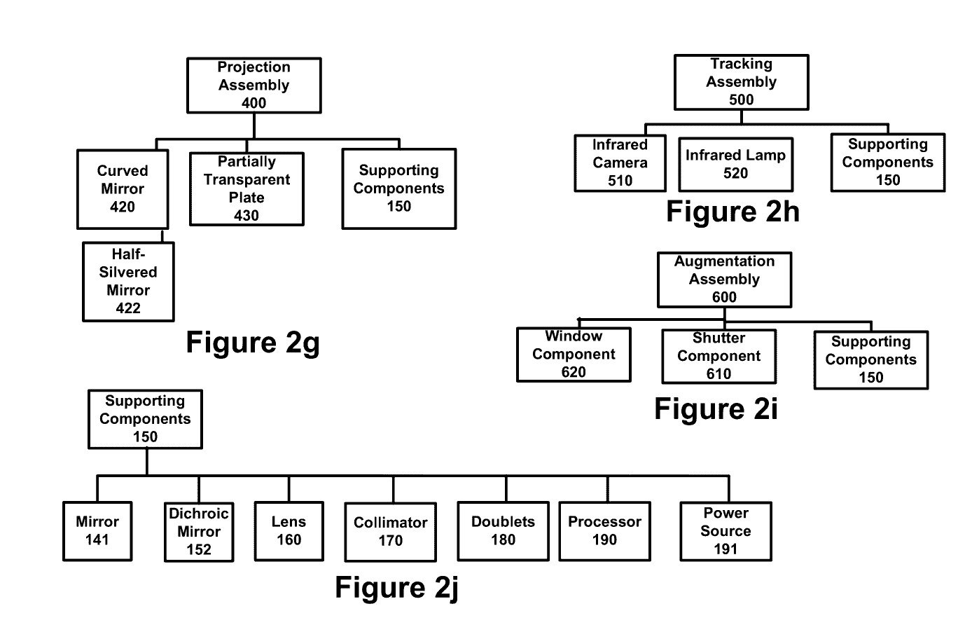

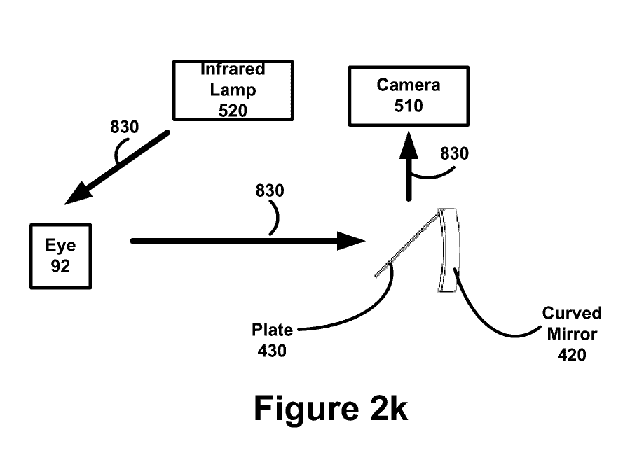

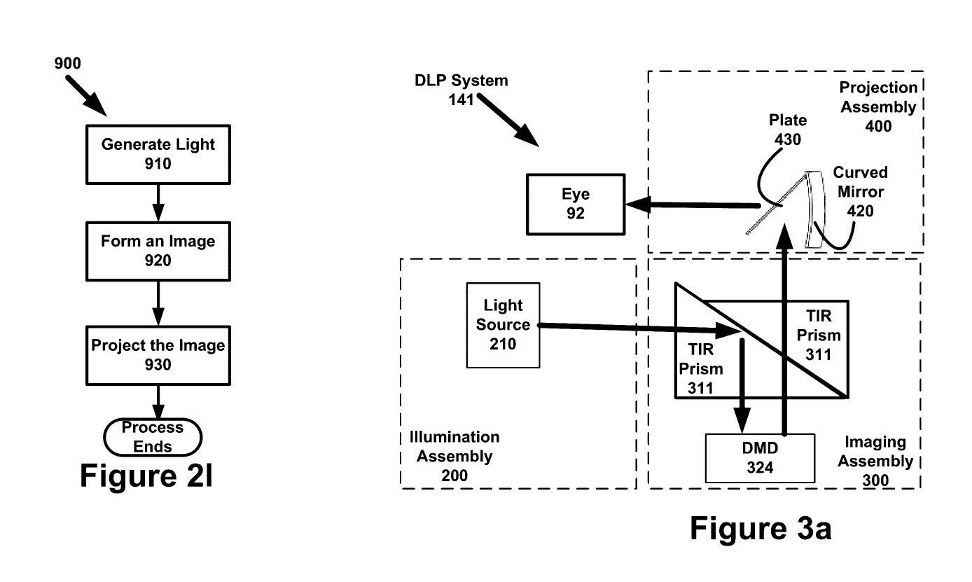

The system 100 can be described in terms of assemblies of components that perform various functions in support of the operation of the system 100. FIG. 2a is a block diagram of a system 100 comprised of an illumination assembly 200 that supplies light 800 to an imaging assembly 300. A modulator 320 of the imaging assembly 300 uses the light 800 from the illumination assembly 200 to create the image 880 that is displayed by the system 100.

As illustrated in FIG. 2b, the system 100 can also include a projection assembly 400 that directs the image 880 from the imaging assembly 300 to a location where it can be accessed by one or more users 90. The image 880 generated by the imaging assembly 300 will often be modified in certain ways before it is displayed by the system 100 to users 90, and thus the image generated by the imaging assembly 300 can also be referred to as an interim image 850 or a work-in-process image 850.

A. Illumination Assembly

An illumination assembly 200 performs the function of supplying light 800 to the system 100 so that an image 880 can be displayed. As illustrated in FIGS. 2a and 2b, the illumination assembly 200 can include a light source 210 for generating light 800. The illumination assembly 200 is also displayed in FIGS. 2b-2d. The illumination assembly 200 generates the light 800 that is used and processed by other assemblies of the system 100.

FIG. 2e is a hierarchy diagram illustrating an example of different components that can be included in the illumination assembly 200. Those components can include but are not limited a wide range of light sources 210, a diffuser assembly 280, and a variety of supporting components 150. Examples of light sources 210 can include but are such as a multi-bulb light source 211, an LED lamp 212, a 3 LED lamp 213, a laser 214, an OLED 215, a CFL 216, an incandescent lamp 218, and a non-angular dependent lamp 219. The light source 210 is where light 800 is generated and moves throughout the rest of the system 100. Thus, each light source 210 is a location 230 for the origination of light 800.

In many instances, it will be desirable to use a 3 LED lamp as a light source, which one LED designated for each primary color of red, green, and blue.

B. Imaging Assembly

An imaging assembly 300 performs the function of creating the image 880 from the light 800 supplied by the illumination assembly 200. As illustrated in FIG. 2a, a modulator 320 can transform the light 800 supplied by the illumination assembly 200 into the image 880 that is displayed by the system 100. As illustrated in FIG. 2b, the image 880 generated by the imaging assembly 300 can sometimes be referred to as an interim image 850 because the image 850 may be focused or otherwise modified to some degree before it is directed to the location where it can be experienced by one or more users 90.

Imaging assemblies 300 can vary significantly based on the type of technology used to create the image. Display technologies such as DLP (digital light processing), LCD (liquid-crystal display), LCOS (liquid crystal on silicon), and other methodologies can involve substantially different components in the imaging assembly 300.

FIG. 2f is a hierarchy diagram illustrating an example of different components that can be utilized in the imaging assembly 300 for the system 100. A prism 310 can be very useful component in directing light to and/or from the modulator 320. DLP applications will typically use an array of TIR prisms 311 or RTIR prisms 312 to direct light to and from a DMD 324.

A modulator 320 (sometimes referred to as a light modulator 320) is the device that modifies or alters the light 800, creating the image 880 that is to be displayed. Modulators 320 can operate using a variety of different attributes of the modulator 320. A reflection-based modulator 322 uses the reflective-attributes of the modulator 320 to fashion an image 880 from the supplied light 800. Examples of reflection-based modulators 322 include but are not limited to the DMD 324 of a DLP display and some LCOS (liquid crystal on silicon) panels 340. A transmissive-based modulator 321 uses the transmissive-attributes of the modulator 320 to fashion an image 880 from the supplied light 800. Examples of transmissive-based modulators 321 include but are not limited to the LCD (liquid crystal display) 330 of an LCD display and some LCOS panels 340. The imaging assembly 300 for an LCOS or LCD system 100 will typically have a combiner cube or some similar device for integrating the different one-color images into a single image 880.

The imaging assembly 300 can also include a wide variety of supporting components 150.

C. Projection Assembly

As illustrated in FIG. 2b, a projection assembly 400 can perform the task of directing the image 880 to its final destination in the system 100 where it can be accessed by users 90. In many instances, the image 880 created by the imaging assembly 300 will be modified in at least some minor ways between the creation of the image 880 by the modulator 320 and the display of the image 880 to the user 90. Thus, the image 880 generated by the modulator 320 of the imaging assembly 400 may only be an interim image 850, not the final version of the image 880 that is actually displayed to the user 90.

FIG. 2g is a hierarchy diagram illustrating an example of different components that can be part of the projection assembly 400. A display 410 is the final destination of the image 880, i.e. the location and form of the image 880 where it can be accessed by users 90. Examples of displays 410 can include an active screen 412, a passive screen 414, an eyepiece 416, and a VRD eyepiece 418.

The projection assembly 400 can also include a variety of supporting components 150 as discussed below.

D. Sensor/Tracking Assembly

FIG. 2d illustrates an example of the system 100 that includes a tracking assembly 500 (which is also referred to as a sensor assembly 500). The sensor assembly 500 can be used to capture information about the user 90, the user's interaction with the image 880, and/or the exterior environment in which the user 90 and system 100 are physically present.

As illustrated in FIG. 2h, the sensor assembly 500 can include a sensor 510, typically a camera such as an infrared camera for capturing an eye-tracking attribute 530 pertaining to eye movements of the viewer 96. A lamp 520 such as an infrared light source to support the functionality of the infrared camera, and a variety of different supporting components 150. In many embodiments of the system 100 that include a tracking assembly 500, the tracking assembly 500 will utilize components of the projection assembly 400 such as the configuration of a curved mirror 420 operating in tandem with a partially transparent plate 430. Such a configuration can be used to capture infrared images of the eye 92 of the viewer 96 while simultaneously delivering images 880 to the eye 92 of the viewer 96. FIG. 2k illustrates an example of the system 100 that includes a sensor/tracking assembly 500 that can be used to capture an eye-tracking attribute 530 that can be used to impact the focal modulation used for depth regions 860 within the image 880.

The sensor assembly 500 can also include sensors 510 intended to capture visual images, video, sounds, motion, position, and other information from the operating environment 80.

E. Augmentation Assembly

An augmentation assembly 600 can allow natural light from the exterior environment 80 in through a window component 620 in the system 100 (the window component 620 can include a shutter component 610) that is capable of being opened or closed. The augmentation assembly 600 supports the capability of an augmentation mode, which can be useful parameter 700 in many contexts that involve an interrupted user 90 of the system 100.

F. Supporting Components

Light 800 can be a challenging resource to manage. Light 800 moves quickly and cannot be constrained in the same way that most inputs or raw materials can be. FIG. 2j is a hierarchy diagram illustrating an example of some supporting components 150, many of which are conventional optical components. Any display technology application will involve conventional optical components such as mirrors 141 (including dichroic mirrors 152) lenses 160, collimators 170, and plates 180. Similarly, any powered device requires a power source 191 and a device capable of displaying an image 880 is likely to have a processor 190.

G. Process Flow View

FIG. 2l illustrates a process flow view of the basic structural elements illustrated in FIG. 2a. Light is generated, then it is modulated into an image (or at least an interim image), and the image is finalized and delivered to a user 90.

### III. DIFFERENT DISPLAY TECHNOLOGIES

The system 100 can be implemented with respect to a wide variety of different display technologies, including but not limited to DLP.

A. DLP Embodiments

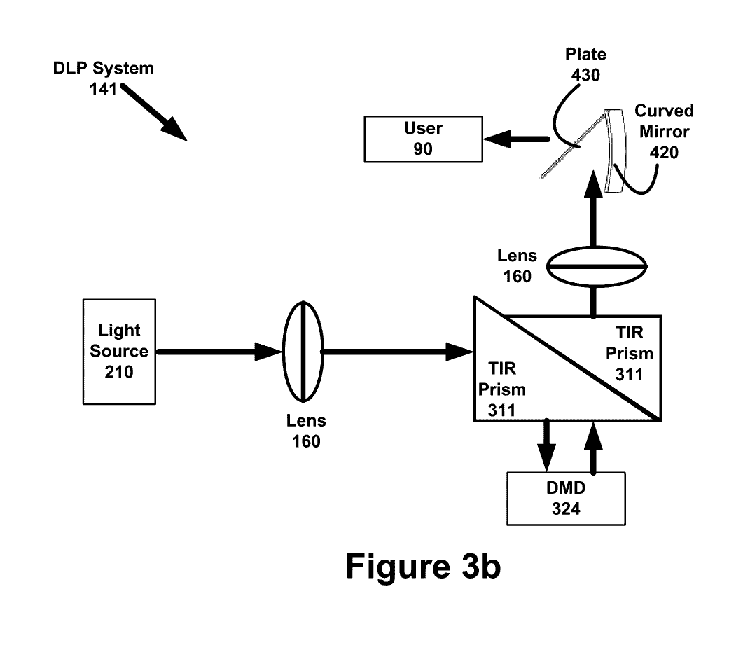

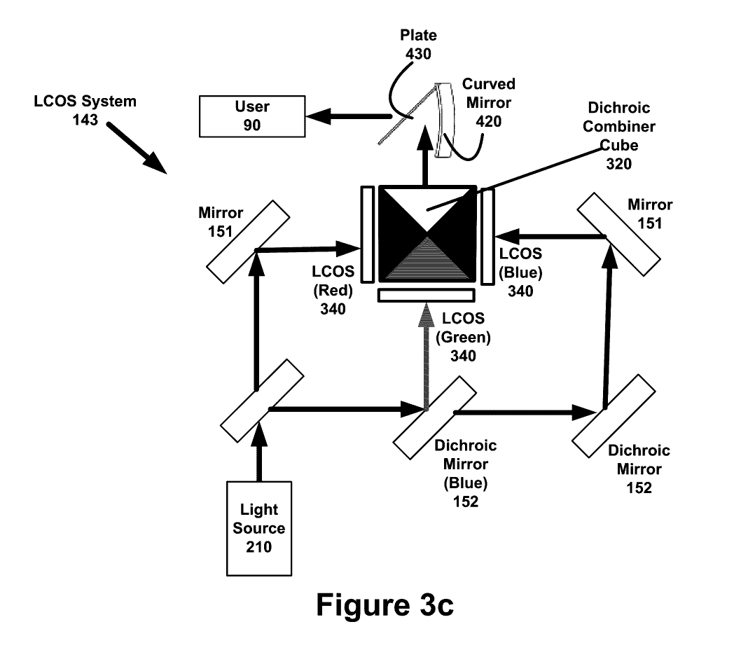

FIG. 3a illustrates an example of a DLP system 141, i.e. an embodiment of the system 100 that utilizes DLP optical elements. DLP systems 141 utilize a DMD 324 (digital micromirror device) comprised of millions of tiny mirrors as the modulator 320. Each micro mirror in the DMD 314 can pertain to a particular pixel in the image 880.

As discussed above, the illumination assembly 200 includes a light source 210 and multiple diffusers 282. The light 800 then passes to the imaging assembly 300. Two TIR prisms 311 direct the light 800 to the DMD 324, the DMD 324 creates an image 880 with that light 800, and the TIR prisms 311 then direct the light 800 embodying the image 880 to the display 410 where it can be enjoyed by one or more users 90.

The tuning lens 710 or other focal modifying component of the tuning assembly 700 can be positioned in a variety of different locations within the light pathway that begins with the light source 210 generating light 800 and ends with the eye 92 of the viewer 96.

FIG. 3b is a more detailed example of a DLP system 141. The illumination assembly 200 includes one or more lenses 160, typically a condensing lens 160 and then a shaping lens 160 (not illustrated) is used to direct the light 800 to the array of TIR prisms 311. A lens 160 is positioned before the display 410 to modify/focus image 880 before providing the image 880 to the users 90. FIG. 3b also includes a more specific term for the light 800 at various stages in the process.

### IV. VRD VISOR EMBODIMENTS

The system 100 can be implemented in a wide variety of different configurations and scales of operation. However, the original inspiration for the conception of using subframe sequences 854 that differentiate different areas of the image 880 based on focal points 870 occurred in the context of a VRD visor system 106 embodied as a VRD visor apparatus 116. A VRD visor apparatus 116 projects the image 880 directly onto the eyes of the user 90. The VRD visor apparatus 116 is a device that can be worn on the head of the user 90. In many embodiments, the VRD visor apparatus 116 can include sound as well as visual capabilities. Such embodiments can include multiple modes of operation, such as visual only, audio only, and audio-visual modes. When used in a non-visual mode, the VRD apparatus 116 can be configured to look like ordinary headphones.

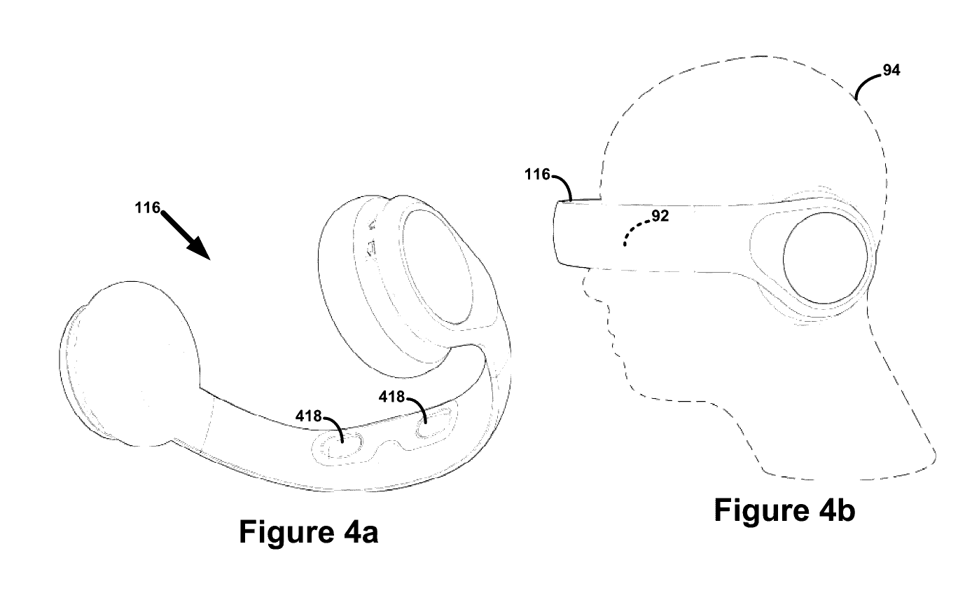

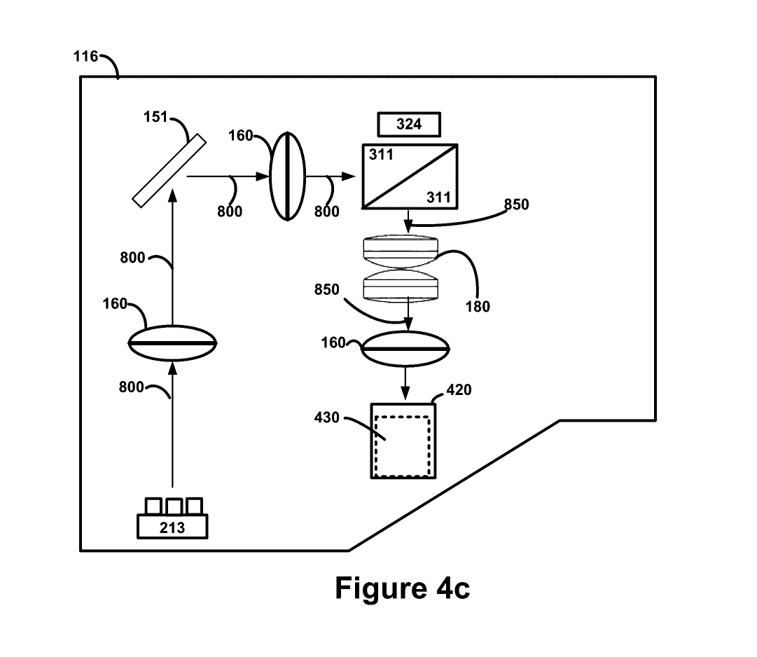

FIG. 4a is a perspective diagram illustrating an example of a VRD visor apparatus 116. Two VRD eyepieces 418 provide for directly projecting the image 880 onto the eyes of the user 90.

FIG. 4b is a side view diagram illustrating an example of a VRD visor apparatus 116 being worn on the head 94 of a user 90. The eyes 92 of the user 90 are blocked by the apparatus 116 itself, with the apparatus 116 in a position to project the image 880 on the eyes 92 of the user 90.

FIG. 4c is a component diagram illustrating an example of a VRD visor apparatus 116 for the left eye 92. A mirror image of FIG. 4c would pertain to the right eye 92.

A 3 LED light source 213 generates the light which passes through a condensing lens 160 that directs the light 800 to a mirror 151 which reflects the light 800 to a shaping lens 160 prior to the entry of the light 800 into an imaging assembly 300 comprised of two TIR prisms 311 and a DMD 324. The interim image 850 from the imaging assembly 300 passes through another lens 160 that focuses the interim image 850 into a final image 880 that is viewable to the user 90 through the eyepiece 416. The tuning assembly 700 is used in conjunction with the subframe sequence 854 to change the focal points 870 of light 800 on a depth region 860 by depth region 860 basis before the viewer 96 has access to the image 880.

### V. ALTERNATIVE EMBODIMENTS

No patent application can expressly disclose in words or in drawings, all of the potential embodiments of an invention. Variations of known equivalents are implicitly included. In accordance with the provisions of the patent statutes, the principles, functions, and modes of operation of the systems 100, methods 900, and apparatuses 110 (collectively the “system” 100) are explained and illustrated in certain preferred embodiments. However, it must be understood that the inventive systems 100 may be practiced otherwise than is specifically explained and illustrated without departing from its spirit or scope.

The description of the system 100 provided above and below should be understood to include all novel and non-obvious alternative combinations of the elements described herein, and claims may be presented in this or a later application to any novel non-obvious combination of these elements. Moreover, the foregoing embodiments are illustrative, and no single feature or element is essential to all possible combinations that may be claimed in this or a later application.

The system 100 represents a substantial improvement over prior art display technologies. Just as there are a wide range of prior art display technologies, the system 100 can be similarly implemented in a wide range of different ways. The innovation of altering the subframe illumination sequence 854 within a particular frame 882 can be implemented at a variety of different scales, utilizing a variety of different display technologies, in both immersive and augmenting contexts, and in both one-way (no sensor feedback from the user 90) and two-way (sensor feedback from the user 90) embodiments.

A. Variations of Scale

Display devices can be implemented in a wide variety of different scales. The monster scoreboard at EverBanks Field (home of the Jacksonville Jaguars) is a display system that is 60 feet high, 362 feet long, and comprised of 35.5 million LED bulbs. The scoreboard is intended to be viewed simultaneously by tens of thousands of people. At the other end of the spectrum, the GLYPH™ visor by Avegant Corporation is a device that is worn on the head of a user and projects visual images directly in the eyes of a single viewer. Between those edges of the continuum are a wide variety of different display systems.

The system 100 displays visual images 808 to users 90 with enhanced light with reduced coherence. The system 100 can be potentially implemented in a wide variety of different scales.

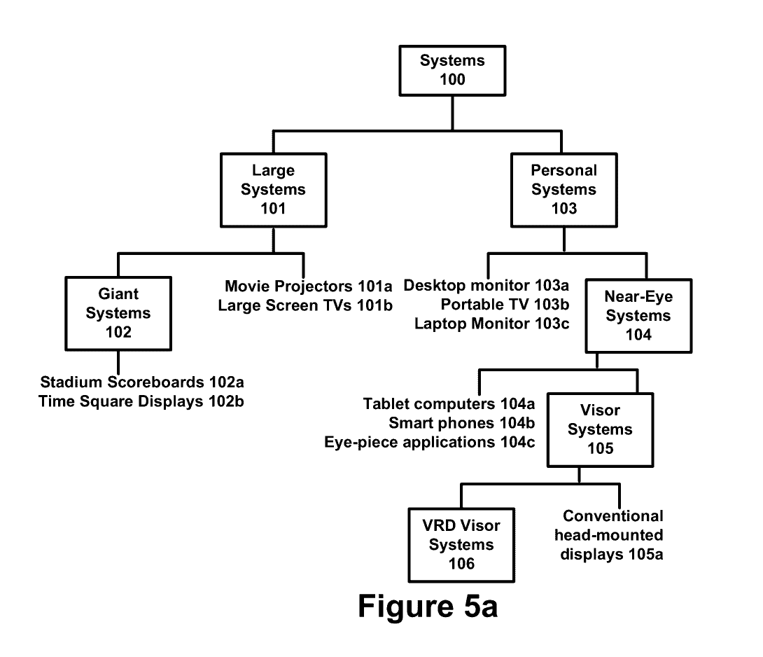

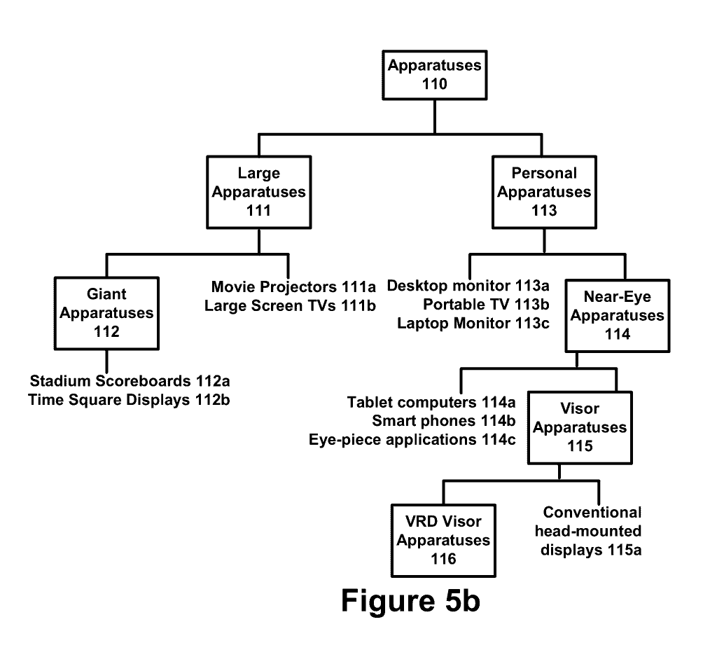

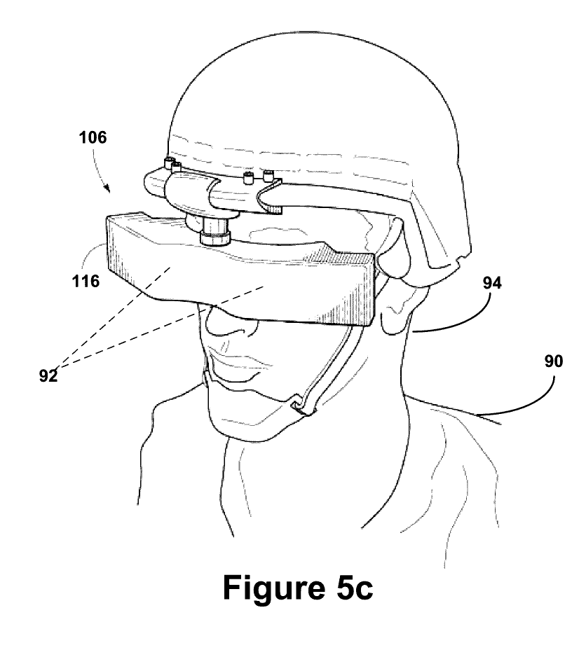

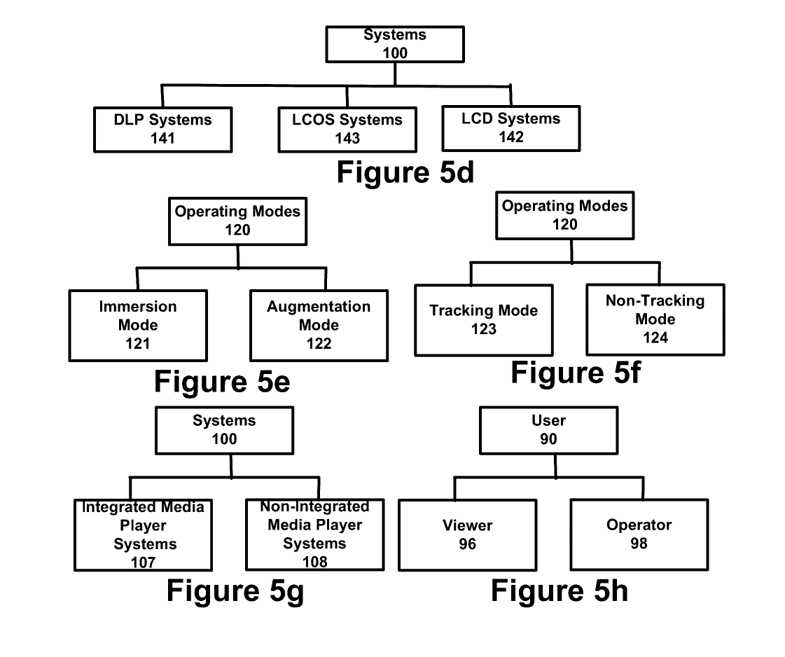

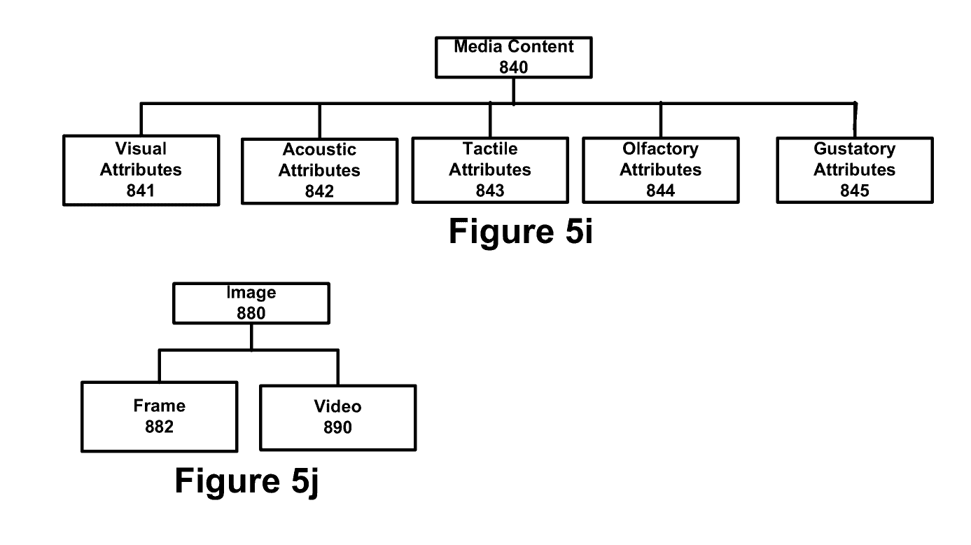

FIG. 5a is a hierarchy diagram illustrating various categories and subcategories pertaining to the scale of implementation for display systems generally, and the system 100 specifically. As illustrated in FIG. 5a, the system 100 can be implemented as a large system 101 or a personal system 103

1. Large Systems

A large system 101 is intended for use by more than one simultaneous user 90. Examples of large systems 101 include movie theater projectors, large screen TVs in a bar, restaurant, or household, and other similar displays. Large systems 101 include a subcategory of giant systems 102, such as stadium scoreboards 102a, the Time Square displays 102b, or other or the large outdoor displays such as billboards off the expressway.

2. Personal Systems

A personal system 103 is an embodiment of the system 100 that is designed to for viewing by a single user 90. Examples of personal systems 103 include desktop monitors 103a, portable TVs 103b, laptop monitors 103c, and other similar devices. The category of personal systems 103 also includes the subcategory of near-eye systems 104.

a. Near-Eye Systems

A near-eye system 104 is a subcategory of personal systems 103 where the eyes of the user 90 are within about 12 inches of the display. Near-eye systems 104 include tablet computers 104a, smart phones 104b, and eye-piece applications 104c such as cameras, microscopes, and other similar devices. The subcategory of near-eye systems 104 includes a subcategory of visor systems 105.

b. Visor Systems

A visor system 105 is a subcategory of near-eye systems 104 where the portion of the system 100 that displays the visual image 200 is actually worn on the head 94 of the user 90. Examples of such systems 105 include virtual reality visors, Google Glass, and other conventional head-mounted displays 105a. The category of visor systems 105 includes the subcategory of VRD visor systems 106.

c. VRD Visor Systems

A VRD visor system 106 is an implementation of a visor system 105 where visual images 200 are projected directly on the eyes of the user. The technology of projecting images directly on the eyes of the viewer is disclosed in a published patent application titled “IMAGE GENERATION SYSTEMS AND IMAGE GENERATING METHODS” (U.S. Ser. No. 13/367,261) that was filed on Feb. 6, 2012, the contents of which are hereby incorporated by reference.

3. Integrated Apparatus

Media components tend to become compartmentalized and commoditized over time. It is possible to envision display devices where an illumination assembly 120 is only temporarily connected to a particular imaging assembly 160. However, in most embodiments, the illumination assembly 120 and the imaging assembly 160 of the system 100 will be permanently (at least from the practical standpoint of users 90) into a single integrated apparatus 110. FIG. 5b is a hierarchy diagram illustrating an example of different categories and subcategories of apparatuses 110. FIG. 5b closely mirrors FIG. 5a. The universe of potential apparatuses 110 includes the categories of large apparatuses 111 and personal apparatuses 113. Large apparatuses 111 include the subcategory of giant apparatuses 112. The category of personal apparatuses 113 includes the subcategory of near-eye apparatuses 114 which includes the subcategory of visor apparatuses 115. VRD visor apparatuses 116 comprise a category of visor apparatuses 115 that implement virtual retinal displays, i.e. they project visual images 200 directly into the eyes of the user 90.

FIG. 5c is a diagram illustrating an example of a perspective view of a VRD visor system 106 embodied in the form of an integrated VRD visor apparatus 116 that is worn on the head 94 of the user 90. Dotted lines are used with respect to element 92 because the eyes 92 of the user 90 are blocked by the apparatus 116 itself in the illustration.

B. Different Categories of Display Technology

The prior art includes a variety of different display technologies, including but not limited to DLP (digital light processing), LCD (liquid crystal displays), and LCOS (liquid crystal on silicon). FIG. 5d, which is a hierarchy diagram illustrating different categories of the system 100 based on the underlying display technology in which the system 200 can be implemented. The system 100 is intended for use as a DLP system 141, but could be potentially be used as an LCOS system 143 or even an LCD system 142 although the means of implementation would obviously differ and the reasons for implementation may not exist. The system 100 can also be implemented in other categories and subcategories of display technologies.

C. Immersion vs. Augmentation

FIG. 5e is a hierarchy diagram illustrating a hierarchy of systems 100 organized into categories based on the distinction between immersion and augmentation. Some embodiments of the system 100 can have a variety of different operating modes 120. An immersion mode 121 has the function of blocking out the outside world so that the user 90 is focused exclusively on what the system 100 displays to the user 90. In contrast, an augmentation mode 122 is intended to display visual images 200 that are superimposed over the physical environment of the user 90. The distinction between immersion and augmentation modes of the system 100 is particularly relevant in the context of near-eye systems 104 and visor systems 105.

Some embodiments of the system 100 can be configured to operate either in immersion mode or augmentation mode, at the discretion of the user 90. While other embodiments of the system 100 may possess only a single operating mode 120.

D. Display Only Vs. Display/Detect/Track/Monitor

Some embodiments of the system 100 will be configured only for a one-way transmission of optical information. Other embodiments can provide for capturing information from the user 90 as visual images 880 and potentially other aspects of a media experience are made accessible to the user 90. Figure ff is a hierarchy diagram that reflects the categories of a one-way system 124 (a non-sensing operating mode 124) and a two-way system 123 (a sensing operating mode 123). A two-way system 123 can include functionality such as retina scanning and monitoring. Users 90 can be identified, the focal point of the eyes 92 of the user 90 can potentially be tracked, and other similar functionality can be provided. In a one-way system 124, there is no sensor or array of sensors capturing information about or from the user 90.

E. Media Players—Integrated Vs. Separate

Display devices are sometimes integrated with a media player. In other instances, a media player is totally separate from the display device. By way of example, a laptop computer can include in a single integrated device, a screen for displaying a movie, speakers for projecting the sound that accompanies the video images, a DVD or BLU-RAY player for playing the source media off a disk. Such a device is also capable of streaming

FIG. 5g is a hierarchy diagram illustrating a variety of different categories of systems 100 based on the whether the system 100 is integrated with a media player or not. An integrated media player system 107 includes the capability of actually playing media content as well as displaying the image 880. A non-integrated media player system 108 must communicate with a media player in order to play media content.

F. Users—Viewers vs. Operators

FIG. 5h is a hierarchy diagram illustrating an example of different roles that a user 90 can have. A viewer 96 can access the image 880 but is not otherwise able to control the functionality of the system 100. An operator 98 can control the operations of the system 100, but cannot access the image 880. In a movie theater, the viewers 96 are the patrons and the operator 98 is the employee of the theater.

G. Attributes of Media Content

As illustrated in FIG. 5i, media content 840 can include a wide variety of different types of attributes. A system 100 for displaying an image 880 is a system 100 that plays media content 840 with a visual attribute 841. However, many instances of media content 840 will also include an acoustic attribute 842 or even a tactile attribute. Some new technologies exist for the communication of olfactory attributes 844 and it is only a matter of time before the ability to transmit gustatory attributes 845 also become part of a media experience in certain contexts.

As illustrated in FIG. 5j, some images 880 are parts of a larger video 890 context. In other contexts, an image 880 can be stand-alone still frame 882.

### VI. GLOSSARY/DEFINITIONS

Table 1 below sets forth a list of element numbers, names, and descriptions/definitions.

| # | Name | Definition/Description |
|---|---|---|
| 80 | Environment | The physical environment in which the user 90 and the apparatus |
| | | 110 are located. This will typically be in a room, but some media |
| | | access devices 130 can used outdoors; in a vehicle, such as a car, |
| | | boat, or plane; and in large public places, such as an airport, |
| | | auditorium, sports stadium, or church. |
| 90 | User | A user 90 is a viewer 96 and/or operator 98 of the system 100. The |
| | | user 90 is typically a human being. In alternative embodiments, |
| | | users 90 can be different organisms such as dogs or cats, or even |
| | | automated technologies such as expert systems, artificial intelligence |
| | | applications, and other similar “entities”. |
| 92 | Eye | An organ of the user 90 that provides for the sense of sight. The eye |
| | | consists of different portions including but not limited to the sclera, |
| | | iris, cornea, pupil, and retina. Some embodiments of the system 100 |
| | | involve a VRD visor apparatus 116 that can project the desired |
| | | image 880 directly onto the eye 92 of the user 90. |
| 94 | Head | The portion of the body of the user 90 that includes the eye 92. |
| | | Some embodiments of the system 100 can involve a visor apparatus |
| | | 115 that is worn on the head 94 of the user 90. |
| 96 | Viewer | A user 90 of the system 100 who views the image 880 provided by |
| | | the system 100. All viewers 96 are users 90 but not all users 90 are |
| | | viewers 96. The viewer 96 does not necessarily control or operate |
| | | the system 100. The viewer 96 can be a passive beneficiary of the |
| | | system 100, such as a patron at a movie theater who is not |
| | | responsible for the operation of the projector or someone wearing a |
| | | visor apparatus 115 that is controlled by someone else. |
| 98 | Operator | A user 90 of the system 100 who exerts control over the processing |
| | | of the system 100. All operators 98 are users 90 but not all users 90 |
| | | are operators 98. The operator 98 does not necessarily view the |
| | | images 880 displayed by the system 100 because the operator 98 |
| | | may be someone operating the system 100 for the benefit of others |
| | | who are viewers 96. For example, the operator 98 of the system 100 |
| | | may be someone such as a projectionist at a movie theater or the |
| | | individual controlling the system 100. |
| 100 | System | A collective configuration of assemblies, subassemblies, |
| | | components, processes, and/or data that provide a user 90 with the |
| | | functionality of engaging in a media experience by accessing a |
| | | media content unit 840. Some embodiments of the system 100 can |
| | | involve a single integrated apparatus 110 hosting all components of |
| | | the system 100 while other embodiments of the system 100 can |
| | | involve different non-integrated device configurations. Some |
| | | embodiments of the system 100 can be large systems 102 or even |
| | | giant system 101 while other embodiments of the system 100 can be |
| | | personal systems 103, such as near-eye systems 104, visor systems |
| | | 105, and VRD visor systems 106. Systems 100 can also be referred |
| | | to as display systems 100. The system 100 is believed to be |
| | | particularly useful in the context of personal system 103. |
| 101 | Giant System | An embodiment of the system 100 intended to be viewed |
| | | simultaneously by a thousand or more people. Examples of giant |
| | | systems 101 include scoreboards at large stadiums, electronic |
| | | billboards such the displays in Time Square in New York City, and |
| | | other similar displays. A giant system 101 is a subcategory of large |
| | | systems 102. |
| 102 | Large System | An embodiment of the system 100 that is intended to display an |
| | | image 880 to multiple users 90 at the same time. A large system |
| | | 102 is not a personal system 103. The media experience provided |
| | | by a large system 102 is intended to be shared by a roomful of |
| | | viewers 96 using the same illumination assembly 200, imaging |
| | | assembly 300, and projection assembly 400. Examples of large |
| | | systems 102 include but are not limited to a projector/screen |
| | | configuration in a movie theater, classroom, or conference room; |
| | | television sets in sports bar, airport, or residence; and scoreboard |
| | | displays at a stadium. Large systems 101 can also be referred to as |
| | | large display systems 101. |
| 103 | Personal | A category of embodiments of the system 100 where the media |
| | System | experience is personal to an individual viewer 96. Common |
| | | examples of personal media systems include desktop computers |
| | | (often referred to as personal computers), laptop computers, portable |
| | | televisions, and near-eye systems 104. Personal systems 103 can |
| | | also be referred to as personal media systems 103. Near-eye |
| | | systems 104 are a subcategory of personal systems 103. |
| 104 | Near-Eye | A category of personal systems 103 where the media experience is |
| | System | communicated to the viewer 96 at a distance that is less than or |
| | | equal to about 12 inches (30.48 cm) away. Examples of near-eye |
| | | systems 103 include but are not limited to tablet computers, smart |
| | | phones, system 100 involving eyepieces, such as cameras, |
| | | telescopes, microscopes, etc., and visor media systems 105,. Near- |
| | | eye systems 104 can also be referred to as near-eye media systems |
| | | 104. |
| 105 | Visor System | A category of near-eye media systems 104 where the device or at |
| | | least one component of the device is worn on the head 94 of the |
| | | viewer 96 and the image 880 is displayed in close proximity to the |
| | | eye 92 of the user 90. Visor systems 105 can also be referred to as |
| | | visor display systems 105. |
| 106 | VRD Visor | VRD stands for a virtual retinal display. VRDs can also be referred |
| | System | to as retinal scan displays (“RSD”) and as retinal projectors (“RP”). |
| | | VRD projects the image 880 directly onto the retina of the eye 92 of |
| | | the viewer 96. A VRD Visor System 106 is a visor system 105 that |
| | | utilizes a VRD to display the image 880 on the eyes 92 of the user |
| | | 90. A VRD visor system 106 can also be referred to as a VRD visor |
| | | display system 106. |
| 110 | Apparatus | A device that provides a user 90 with the ability to engage in a media |
| | | experience 840, i.e. interact with a media content unit 840. The |
| | | apparatus 110 can be partially or even fully integrated with a media |
| | | player 848. Many embodiments of the apparatus 110 will have a |
| | | capability to communicate both acoustic attributes 842 and visual |
| | | attributes 841 of the media experience 840 to the user 90. |
| | | Embodiments of the apparatus 110 that provide for communicating |
| | | visual contentThe apparatus 110 can include the illumination |
| | | assembly 200, the imaging assembly 300, and the projection |
| | | assembly 400. In some embodiments, the apparatus 110 includes |
| | | the media player 848 that plays the media content 840. In other |
| | | embodiments, the apparatus 110 does not include the media player |
| | | 848 that plays the media content 840. Different configurations and |
| | | connection technologies can provide varying degrees of “plug and |
| | | play” connectivity that can be easily installed and removed by users |
| | | 90. |
| 111 | Giant Apparatus | An apparatus 110 implementing an embodiment of a giant system |
| | | 101. Common examples of a giant apparatus 111 include the |
| | | scoreboards at a professional sports stadium or arena. |
| 112 | Large | An apparatus 110 implementing an embodiment of a large system |
| | Apparatus | 102. Common examples of large apparatuses 111 include movie |
| | | theater projectors and large screen television sets. A large |
| | | apparatus 111 is typically positioned on a floor or some other support |
| | | structure. A large apparatus 111 such as a flat screen TV can also |
| | | be mounted on a wall. |
| 113 | Personal Media | An apparatus 110 implementing an embodiment of a personal |
| | Apparatus | system 103. Many personal apparatuses 112 are highly portable |
| | | and are supported by the user 90. Other embodiments of personal |
| | | media apparatuses 113 are positioned on a desk, table, or similar |
| | | surface. Common examples of personal apparatuses 113 include |
| | | desktop computers, laptop computers, and portable televisions. |
| 114 | Near-Eye | An apparatus 110 implementing an embodiment of a near-eye |
| | Apparatus | system 104. Many near-eye apparatuses 114 are either worn on the |
| | | head (are visor apparatuses 115) or are held in the hand of the user |
| | | 90. Examples of near-eye apparatuses 114 include smart phones, |
| | | tablet computers, camera eye-pieces and displays, microscope eye- |
| | | pieces and displays, gun scopes, and other similar devices. |
| 115 | Visor Apparatus | An apparatus 110 implementing an embodiment of a visor system |
| | | 105. The visor apparatus 115 is worn on the head 94 of the user 90. |
| | | The visor apparatus 115 can also be referred simply as a visor 115. |
| 116 | VRD Visor | An apparatus 110 in a VRD visor system 106. Unlike a visor |
| | Apparatus | apparatus 114, the VRD visor apparatus 115 includes a virtual retinal |
| | | display that projects the visual image 200 directly on the eyes 92 of |
| | | the user 90. A VRD visor apparatus 116 is disclosed in U.S. Pat. |
| | | No. 8,982,014, the contents of which are incorporated by |
| | | reference in their entirety. |
| 120 | Operating | Some embodiments of the system 100 can be implemented in such |
| | Modes | a way as to support distinct manners of operation. In some |
| | | embodiments of the system 100, the user 90 can explicitly or |
| | | implicitly select which operating mode 120 controls. In other |
| | | embodiments, the system 100 can determine the applicable |
| | | operating mode 120 in accordance with the processing rules of the |
| | | system 100. In still other embodiments, the system 100 is |
| | | implemented in such a manner that supports only one operating |
| | | mode 120 with respect to a potential feature. For example, some |
| | | systems 100 can provide users 90 with a choice between an |
| | | immersion mode 121 and an augmentation mode 122, while other |
| | | embodiments of the system 100 may only support one mode 120 or |
| | | the other. |
| 121 | Immersion | An operating mode 120 of the system 100 in which the outside world |
| | | is at least substantially blocked off visually from the user 90, such |
| | | that the images 880 displayed to the user 90 are not superimposed |
| | | over the actual physical environment of the user 90. In many |
| | | circumstances, the act of watching a movie is intended to be an |
| | | immersive experience. |
| 122 | Augmentation | An operating mode 120 of the system 100 in which the image 880 |
| | | displayed by the system 100 is added to a view of the physical |
| | | environment of the user 90, i.e. the image 880 augments the real |
| | | world. Google Glass is an example of an electronic display that can |
| | | function in an augmentation mode. |
| 126 | Sensing | An operating mode 120 of the system 100 in which the system 100 |
| | | captures information about the user 90 through one or more sensors. |
| | | Examples of different categories of sensing can include eye tracking |
| | | pertaining to the user's interaction with the displayed image 880, |
| | | biometric scanning such as retina scans to determine the identity of |
| | | the user 90, and other types of sensor readings/measurements. |
| 127 | Non-Sensing | An operating mode 120 of the system 100 in which the system 100 |
| | | does not capture information about the user 90 or the user's |
| | | experience with the displayed image 880. |
| 140 | Display | A technology for displaying images. The system 100 can be |
| | Technology | implemented using a wide variety of different display technologies. |
| | | Examples of display technologies 140 include digital light processing |
| | | (DLP), liquid crystal display (LCD), and liquid crystal on silicon |
| | | (LCOS). Each of these different technologies can be implemented in |
| | | a variety of different ways. |
| 141 | DLP System | An embodiment of the system 100 that utilizes digital light processing |
| | | (DLP) to compose an image 880 from light 800. |
| 142 | LCD System | An embodiment of the system 100 that utilizes liquid crystal display |
| | | (LCD) to compose an image 880 from light 800. |
| 143 | LCOS System | An embodiment of the system 100 that utilizes liquid crystal on |
| | | silicon (LCOS) to compose an image 880 from light 800. |
| 150 | Supporting | Regardless of the context and configuration, a system 100 like any |
| | Components | electronic display is a complex combination of components and |
| | | processes. Light 800 moves quickly and continuously through the |
| | | system 100. Various supporting components 150 are used in |
| | | different embodiments of the system 100. A significant percentage |
| | | of the components of the system 100 can fall into the category of |
| | | supporting components 150 and many such components 150 can be |
| | | collectively referred to as “conventional optics”. Supporting |
| | | components 150 can be necessary in any implementation of the |
| | | system 100 in that light 800 is an important resource that must be |
| | | controlled, constrained, directed, and focused to be properly |
| | | harnessed in the process of transforming light 800 into an image 880 |
| | | that is displayed to the user 90. The text and drawings of a patent |
| | | are not intended to serve as product blueprints. One of ordinary skill |
| | | in the art can devise multiple variations of supplementary |
| | | components 150 that can be used in conjunction with the innovative |
| | | elements listed in the claims, illustrated in the drawings, and |
| | | described in the text. |
| 151 | Mirror | An object that possesses at least a non-trivial magnitude of |
| | | reflectivity with respect to light. Depending on the context, a |
| | | particular mirror could be virtually 100% reflective while in other |
| | | cases merely 50% reflective. Mirrors 151 can be comprised of a |
| | | wide variety of different materials, and configured in a wide variety of |
| | | shapes and sizes. |
| 152 | Dichroic Mirror | A mirror 151 with significantly different reflection or transmission |
| | | properties at two different wavelengths. |
| 160 | Lens | An object that possesses at least a non-trivial magnitude of |
| | | transmissivity. Depending on the context, a particular lens could be |
| | | virtually 100% transmissive while in other cases merely about 50% |
| | | transmissive. A lens 160 is often used to focus and/or light 800. |
| 170 | Collimator | A device that narrows a beam of light 800. |
| 180 | Plate | An object that possesses a non-trivial magnitude of reflectiveness |
| | | and transmissivity. |
| 190 | Processor | A central processing unit (CPU) that is capable of carrying out the |
| | | instructions of a computer program. The system 100 can use one or |
| | | more processors 190 to communicate with and control the various |
| | | components of the system 100. |
| 191 | Power Source | A source of electricity for the system 100. Examples of power |
| | | sources include various batteries as well as power adaptors that |
| | | provide for a cable to provide power to the system 100. Different |
| | | embodiments of the system 100 can utilize a wide variety of different |
| | | internal and external power sources. 191. Some embodiments can |
| | | include multiple power sources 191. |
| 200 | Illumination | A collection of components used to supply light 800 to the imaging |
| | Assembly | assembly 300. Common example of components in the illumination |
| | | assembly 200 include light sources 210 and diffusers. The |
| | | illumination assembly 200 can also be referred to as an illumination |
| | | subsystem 200. |
| 210 | Light Source | A component that generates light 800. There are a wide variety of |
| | | different light sources 210 that can be utilized by the system 100. |
| 211 | Multi-Prong | A light source 210 that includes more than one illumination element. |
| | Light Source | A 3-colored LED lamp 213 is a common example of a multi-prong |
| | | light source 212. |
| 212 | LED Lamp | A light source 210 comprised of a light emitting diode (LED). |
| 213 | 3 LED Lamp | A light source 210 comprised of three light emitting diodes (LEDs). |
| | | In some embodiments, each of the three LEDs illuminates a different |
| | | color, with the 3 LED lamp eliminating the use of a color wheel. |
| 214 | Laser | A light source 210 comprised of a device that emits light through a |
| | | process of optical amplification based on the stimulated emission of |
| | | electromagnetic radiation. |
| 215 | OLED Lamp | A light source 210 comprised of an organic light emitting diode |
| | | (OLED). |
| 216 | CFL Lamp | A light source 210 comprised of a compact fluorescent bulb. |
| 217 | Incandescent | A light source 210 comprised of a wire filament heated to a high |
| | Lamp | temperature by an electric current passing through it. |
| 218 | Non-Angular | A light source 210 that projects light that is not limited to a specific |
| | Dependent | angle. |
| | Lamp | |
| 219 | Arc Lamp | A light source 210 that produces light by an electric arc. |
| 230 | Light Location | A location of a light source 210, i.e. a point where light originates. |
| | | Configurations of the system 100 that involve the projection of light |
| | | from multiple light locations 230 can enhance the impact of the |
| | | diffusers 282. |
| 300 | Imaging | A collective assembly of components, subassemblies, processes, |
| | Assembly | and light 800 that are used to fashion the image 880 from light 800. |
| | | In many instances, the image 880 initially fashioned by the imaging |
| | | assembly 300 can be modified in certain ways as it is made |
| | | accessible to the user 90. The modulator 320 is the component of |
| | | the imaging assembly 300 that is primarily responsible for fashioning |
| | | an image 880 from the light 800 supplied by the illumination |
| | | assembly 200. |
| 310 | Prism | A substantially transparent object that often has triangular bases. |
| | | Some display technologies 140 utilize one or more prisms 310 to |
| | | direct light 800 to a modulator 320 and to receive an image 880 or |
| | | interim image 850 from the modulator 320. |
| 311 | TIR Prism | A total internal reflection (TIR) prism 310 used in a DLP 141 to direct |
| | | light to and from a DMD 324. |
| 312 | RTIR Prism | A reverse total internal reflection (RTIR) prism 310 used in a DLP |
| | | 141 to direct light to and from a DMD 324. |
| 320 | Modulator or | A device that regulates, modifies, or adjusts light 800. Modulators |
| | Light Modulator | 320 form an image 880 or interim image 850 from the light 800 |
| | | supplied by the illumination assembly 200. Common categories of |
| | | modulators 320 include transmissive-based light modulators 321 and |
| | | reflection-based light modulators 322. |
| 321 | Transmissive- | A modulator 320 that fashions an image 880 from light 800 utilizing a |
| | Based Light | transmissive property of the modulator 320. LCDs are a common |
| | Modulator | example of a transmissive-based light modulator 321. |
| 322 | Reflection- | A modulator 320 that fashions an image 880 from light 800 utilizing a |
| | Based Light | reflective property of the modulator 320. Common examples of |
| | Modulator | reflection-based light modulators 322 include DMDs 324 and LCOSs |
| | | 340. |
| 324 | DMD | A reflection-based light modulator 322 commonly referred to as a |
| | | digital micro mirror device. A DMD 324 is typically comprised of a |
| | | several thousand microscopic mirrors arranged in an array on a |
| | | processor 190, with the individual microscopic mirrors corresponding |
| | | to the individual pixels in the image 880. |
| 330 | LCD Panel or | A light modulator 320 in an LCD (liquid crystal display). A liquid |
| | LCD | crystal display that uses the light modulating properties of liquid |
| | | crystals. Each pixel of an LCD typically consists of a layer of |
| | | molecules aligned between two transparent electrodes, and two |
| | | polarizing filters (parallel and perpendicular), the axes of |
| | | transmission of which are (in most of the cases) perpendicular to |
| | | each other. Without the liquid crystal between the polarizing filters, |
| | | light passing through the first filter would be blocked by the second |
| | | (crossed) polarizer. Some LCDs are transmissive while other LCDs |
| | | are transflective. |
| 340 | LCOS Panel or | A light modulator 320 in an LCOS (liquid crystal on silicon) display. |
| | LCOS | A hybrid of a DMD 324 and an LCD 330. Similar to a DMD 324, |
| | | except that the LCOS 326 uses a liquid crystal layer on top of a |
| | | silicone backplane instead of individual mirrors. An LCOS 244 can |
| | | be transmissive or reflective. |
| 350 | Dichroid | A device used in an LCOS or LCD display that combines the |
| | Combiner Cube | different colors of light 800 to formulate an image 880 or interim |
| | | image 850. |
| 400 | Projection | A collection of components used to make the image 880 accessible |
| | Assembly | to the user 90. The projection assembly 400 includes a display 410. |
| | | The projection assembly 400 can also include various supporting |
| | | components 150 that focus the image 880 or otherwise modify the |
| | | interim image 850 transforming it into the image 880 that is displayed |
| | | to one or more users 90. The projection assembly 400 can also be |
| | | referred to as a projection subsystem 400. |
| 410 | Display or | An assembly, subassembly, mechanism, or device by which the |
| | Screen | image 880 is made accessible to the user 90. Examples of displays |
| | | 410 include active screens 412, passive screens 414, eyepieces 416, |
| | | and VRD eyepieces 418. |
| 412 | Active Screen | A display screen 410 powered by electricity that displays the image |
| | | 880. |
| 414 | Passive Screen | A non-powered surface on which the image 880 is projected. A |
| | | conventional movie theater screen is a common example of a |
| | | passive screen 412. |
| 416 | Eyepiece | A display 410 positioned directly in front of the eye 92 of an |
| | | individual user 90. |
| 418 | VRD Eyepiece | An eyepiece 416 that provides for directly projecting the image 880 |
| | or VRD Display | on the eyes 92 of the user 90. A VRD eyepiece 418 can also be |
| | | referred to as a VRD display 418. |
| 420 | Curved Mirror | An at least partially reflective surface that in conjunction with the |
| | | splitting plate 430 projects the image 880 onto the eye 92 of the |
| | | viewer 96. The curved mirror 420 can perform additional functions in |
| | | embodiments of the system 100 that include a sensing mode 126 |
| | | and/or an augmentation mode 122. |
| 430 | Splitting Plate | A partially transparent and partially reflective plate that in conjunction |
| | | with the curved mirror 420 can be used to direct the image 880 to the |
| | | user 90 while simultaneously tracking the eye 92 of the user 90. |
| 500 | Sensor | The sensor assembly 500 can also be referred to as a tracking |
| | Assembly | assembly 500. The sensor assembly 500 is a collection of |
| | | components that can track the eye 92 of the viewer 96 while the |
| | | viewer 96 is viewing an image 880. The tracking assembly 500 can |
| | | include an infrared camera 510, and infrared lamp 520, and variety of |
| | | supporting components 150. The assembly 500 can also include a |
| | | quad photodiode array or CCD. |
| 510 | Sensor | A component that can capture an eye-tracking attribute 530 from the |
| | | eye 92 of the viewer 96. The sensor 510 is typically a camera, such |
| | | as an infrared camera. |
| 511 | External | A sensor 510 that captures images of the exterior operating |
| | Camera | environment 80. |
| 512 | Microphone | A sensor 510 that captures sounds of the exterior operating |
| | | environment 80. |
| 513 | Motion Sensor | A sensor 510 that detects motion in the operating environment 80. |
| 514 | Position Sensor | A sensor 510 that identifies a location of the apparatus 110. |
| 520 | Lamp | A light source for the sensor 510. For embodiments of the sensor |
| | | 510 involving a camera 510, a light source is typically very helpful. In |
| | | some embodiments, the lamp 520 is an infrared lamp and the |
| | | camera is an infrared camera. This prevents the viewer 96 from |
| | | being impacted by the operation of the sensor assembly 500. |
| 530 | Eye-Tracking | An attribute pertaining to the movement and/or position of the eye 92 |
| | Attribute | of the viewer 96. Some embodiments of the system 100 can be |
| | | configured to selectively influence the focal point 870 of light 800 in |
| | | an area of the image 880 based on one or more eye-tracking |
| | | attributes 530 measured or captured by the sensor assembly 500. |
| 550 | Output Devices | A device or component that communicates some aspect of the |
| | | media experience 840 to the user 90. The system 100 can utilize a |
| | | wide variety of output devise 550, many of which may be stand- |
| | | alone, non-integrated, plug and play types of components. Common |
| | | examples of output devices 550 include speakers 560 and displays |
| | | 410. Any mechanism for providing output or feedback to a user 90 in |
| | | the prior art can be incorporated into the system 100. |
| 560 | Speaker | A device or component that can communicate the acoustic attributes |
| | | 843 from the media content 840 to the user 90 of the apparatus 110. |
| | | Common examples of speakers 560 include headphones and |
| | | earphones. |
| 570 | Haptic | A device or component that can provide haptic feedback to the user |
| | Feedback | 90. |
| | Component | |
| 600 | Augmentation | A collection of components that provide for allowing or precluding an |
| | Assembly | exterior environment image 650 from reaching the eye 92 of the |
| | | viewer 96. |
| 610 | Shutter | A device that provides for either allowing or disallowing exterior light |
| | Component | from reaching the eyes 92 of the viewer 96 while the apparatus 110 |
| | | is being worn by the viewer 96. |
| 620 | Window | A passageway for light from the exterior environment in an |
| | | embodiment that is not fully immersive. |
| 650 | Exterior Light | The surroundings of the system 100 or apparatus 110. Some |
| | | embodiments of the system 100 can factor in lighting conditions of |
| | | the exterior environment 650 in supplying light 800 for the display of |
| | | images 880. |
| 700 | Parameters | An at least substantially comprehensive compilation of different ways |
| | | in which the apparatus 110 can operate. The particular configuration |
| | | 705 of parameters 700 that will be operable at any particular time will |
| | | depend on the defining of one or more triggers 750. Examples of |
| | | categories of parameters 700 include but are not limited to a sound |
| | | parameter 710, a display parameter 720, a progression parameter |
| | | 730, and a haptic parameter 740. |
| 705 | Configuration | A subset of operating parameters 700 from the universe of potential |
| | | operating parameters 700. Different triggers 750 can result in |
| | | different configurations 705. The system 100 can be implemented to |
| | | facilitate automatic changes from one configuration 705 of |
| | | parameters 700 to another configuration 705 of parameters 700 |
| | | based on or more triggers 750. |
| 710 | Sound | A parameter 700 pertaining to the communication of acoustic |
| | Parameters | attributes 842 in the media experience 840 by the system 100 to the |
| | | user 90. Examples of sound parameters 710 can include but are not |
| | | limited to an off/mute 711, a temporarily reduced volume 712, an |
| | | alert 713, an external sound amplification 714, a message 715, an |
| | | ongoing volume change 716. |
| 711 | Off/Mute | The sound parameter 710 where sound ceases to be communicated |
| | | by the system 100 to the user 90. |
| 712 | Temporarily | The sound parameter 710 where sound is temporarily reduced in |
| | Reduced | volume for a predefined period of time. This can serve as a |
| | Volume | notification to the user 90 as well as provide the user 90 with a time |
| | | to react to the applicable trigger 750. |
| 713 | Alert | An audible notification can be communicated to the user 90. |
| 714 | External Sound | In addition to or in conjunction with a reduction in the volume of the |
| | Amplification | media experience, the system 100 can import sounds from the |
| | | environment 80 that are captured via a microphone or other similar |
| | | sensor and the play that sound through the speakers 560 of the |
| | | system 100. |
| 715 | Ongoing | The sound parameter 710 where the volume is changed on a non- |
| | Volume Change | temporary (i.e. ongoing basis). |
| 720 | Display | A parameter 700 pertaining to the communication of visual attributes |
| | Parameters | 841 in the media experience 840 to the user 90 by the system 100. |
| | | Examples of display parameters 720 can include but are not limited |
| | | to an off 721, a dimmed display 722, an an/external view 723, an |
| | | on/augmented view 724, a flash 725, a verbal alert 726, and an in |
| | | increased brightness 727. Display parameters 720 can be temporary |
| | | (for a pre-defined period of time) or ongoing. |
| 721 | Off | A display parameter 720 where the communication of visual images |
| | | ceases. |
| 722 | Dimmed | A display parameter 720 where the display 410 is dimmed, i.e. |
| | | images 880 are displayed with light of reduced intensity. |
| 723 | Off/External | A display parameter 720 where the media content 840 is shut off, but |
| | View | a view of the operating environment 80 is displayed through a |
| | | window or through the display 410. |
| 724 | On/Augmented | A display parameter 720 where media content 840 continues to play, |
| | View | but in an augmentation mode 122. |
| 725 | Flash | A display parameter 720 where media content 840 continues to play, |
| | | but the display 410 flashes a few short pulses to notify the user 90. |
| 726 | Written Alert | A display parameter 720 that involves a written notification being |
| | | overlaid on the display 410. |
| 727 | Increased | A display parameter 720 that involves a temporary increase in the |
| | Brightness | brightness of the image 880 being displayed. |
| 730 | Progression | A parameter 700 pertaining to sequential progression of the media |
| | Parameters | experience. Examples of progression parameters 730 can include |
| | | but are not limited to a stop 731, a pause 732, and a timed-pause |
| | | 733. |
| 731 | Stop | A progression parameter 730 where the media experience 840 stops |
| | | playing. |
| 732 | Pause | A progression parameter 730 where the media experience 840 is |
| | | paused. |
| 733 | Timed-Pause | A progression parameter 730 where the media experience 840 is |
| | | paused for a specified period of time, before the media experience |
| | | 840 automatically starts playing again. |
| 734 | Play | A progression parameter 730 that involves the continued playing the |
| | | media experience 840. |
| 735 | Bookmark | A progression parameter 730 that involves marking the point in time |
| | | in the media experience 840 when a particular trigger 750 occurred. |
| 740 | Haptic | A category of parameters 700 that can be configured by the system |
| | | 100. Haptic communication typically involves vibration of a device. In |
| | | more involved/immersive systems 100, it might include a chair or |
| | | other devices. |
| 741 | Haptic Alert | The invocation of vibration to alert the user 90 to something. Haptic |
| | | alerts 741 can be effective way to get the attention of a user 90 |
| | | engaged in primarily visual and/or acoustic content. |
| 742 | Muted Haptic | For a media experience 840 that involves haptic feedback, the ability |
| | | to mute that feedback can be a desirable parameter 700. |
| 743 | Increase Haptic | One way to get the attention of a user 90 is to increase the |
| | | magnitude of haptic feedback. |
| 744 | Decrease | A decrease in the magnitude of the haptic communication from the |
| | Haptic | system 100 or apparatus 110 to the user 90. |
| 750 | Trigger | An event defined with respect to one or more inputs that is linked to |
| | | one or more configurations 705. Examples of different categories of |
| | | triggers 750 include but are not limited to user actions 760 and |
| | | environmental stimuli 780. |
| 760 | User Action | An activity by a user 90 that is linked or can be linked to a change in |
| | | the configuration 705 of the system 100. Examples of user actions |
| | | 760 can include but are not limited to use or manipulation of a user |
| | | control 761, an eye-movement gesture 762, a kinetic gesture 763, a |
| | | pre-defined user gesture 764, an input from peripheral device 765, a |
| | | pre-defined voice command 766, and a pre-defined schedule 767. |
| 761 | User Control | A user action 760 that involves the use or manipulation of a user |
| | | control, such as a button, joystick, keypad, etc. |
| 762 | Eye-Movement | A user action 760 that involves the movement of the eye 92 of the |
| | Gesture | user 90. |
| 763 | Kinetic Gesture | A user action 760 that involves the motion of the user 90. |
| 764 | Pre-Defined | A user action 760 that involves a gesture pre-defined by the user 90. |
| | User Gesture | |
| 765 | Peripheral | A user action 760 that is in the form of an input received through a |
| | Device Input | peripheral device. |
| 766 | Pre-Defined | A user action 760 that is in the form of a voice command captured |
| | Voice | through a microphone or similar sensor. |
| | Command | |
| 767 | Pre-Defined | A user action 760 in the form of a scheduled date/time. For |
| | Schedule | example, the system 100 can be used as an alarm clock in some |
| | | contexts. In other contexts, a user 90 can set alarms such as when |
| | | playing video games and wanting to avoid forgetting about the time |
| | | and being late for a dinner date. |
| 780 | Environmental | An condition or attribute from the operating environment 780 that is |
| | Stimulus | linked or can be linked to a change a change in the configuration 705 |
| | | of the system 100. Examples of environmental stimuli 780 can |
| | | include but are not limited to an external sounds 781, an external |
| | | light 782, a detected location 783, a detected proximity 784, a |
| | | detected motion 785, and an external communication 785. |
| 781 | External Sound | A sound from the operating environment 80 that is captured by a |
| | | microphone. |
| 782 | External Light | A temporary pulse of light or a continuous source of light in the |
| | | operating environment 80. |
| 783 | Detected | A GPS location. This can be a highly useful trigger 750 for a user 90 |
| | Location | who is traveling. |
| 784 | Detected | The detection of an object in close proximity to the user 90 and/or |
| | Proximity | apparatus 110. |
| 785 | Detected | The detection of a moving object in the operating environment 80. |
| | Motion | |
| 786 | External | A phone call, e-mail, text message, or other form of communication |
| | Communication | that can be routed by the user 90 through the system 100. By way of |
| | | example, important communications can be differentiated based on |
| | | the type of communication and the other person involved in the |
| | | communication. It is anticipated that users 90 may route e-mail, |
| | | phone calls, and other communications through the apparatus 110. |
| 800 | Light | Light 800 is the media through which an image is conveyed, and light |
| | | 800 is what enables the sense of sight. Light is electromagnetic |
| | | radiation that is propagated in the form of photons. |
| 810 | Pulse | An emission of light 800. A pulse 810 of light 800 can be defined |
| | | with respect to duration, wavelength, and intensity. |
| 840 | Media Content | The image 880 displayed to the user 90 by the system 100 can in |
| | | many instances, be but part of a broader media experience. A unit |
| | | of media content 840 will typically include visual attributes 841 and |
| | | acoustic attributes 842. Tactile attributes 843 are not uncommon in |
| | | certain contexts. It is anticipated that the olfactory attributes 844 and |
| | | gustatory attributes 845 may be added to media content 840 in the |
| | | future. |
| 841 | Visual Attributes | Attributes pertaining to the sense of sight. The core function of the |
| | | system 100 is to enable users 90 to experience visual content such |
| | | as images 880 or video 890. In many contexts, such visual content |
| | | will be accompanied by other types of content, most commonly |
| | | sound or touch. In some instances, smell or taste content may also |
| | | be included as part of the media content 840. |
| 842 | Acoustic | Attributes pertaining to the sense of sound. The core function of the |
| | Attributes | system 100 is to enable users 90 to experience visual content such |
| | | as images 880 or video 890. However, such media content 840 will |
| | | also involve other types of senses, such as the sense of sound. The |
| | | system 100 and apparatuses 110 embodying the system 100 can |
| | | include the ability to enable users 90 to experience tactile attributes |
| | | 843 included with other types of media content 840. |
| 843 | Tactile | Attributes pertaining to the sense of touch. Vibrations are a common |
| | Attributes | example of media content 840 that is not in the form of sight or |
| | | sound. The system 100 and apparatuses 110 embodying the |
| | | system 100 can include the ability to enable users 90 to experience |
| | | tactile attributes 843 included with other types of media content 840. |
| 844 | Olfactory | Attributes pertaining to the sense of smell. It is anticipated that |
| | Attributes | future versions of media content 840 may include some capacity to |
| | | engage users 90 with respect to their sense of smell. Such a |
| | | capacity can be utilized in conjunction with the system 100, and |
| | | potentially integrated with the system 100. The iPhone app called |
| | | oSnap is a current example of gustatory attributes 845 being |
| | | transmitted electronically. |
| 845 | Gustatory | Attributes pertaining to the sense of taste. It is anticipated that future |
| | Attributes | versions of media content 840 may include some capacity to engage |
| | | users 90 with respect to their sense of taste. Such a capacity can be |
| | | utilized in conjunction with the system 100, and potentially integrated |
| | | with the system 100. |
| 848 | Media Player | The system 100 for displaying the image 880 to one or more users |
| | | 90 may itself belong to a broader configuration of applications and |
| | | systems. A media player 848 is device or configuration of devices |
| | | that provide the playing of media content 840 for users. Examples of |
| | | media players 848 include disc players such as DVD players and |
| | | BLU-RAY players, cable boxes, tablet computers, smart phones, |
| | | desktop computers, laptop computers, television sets, and other |
| | | similar devices. Some embodiments of the system 100 can include |
| | | some or all of the aspects of a media player 848 while other |
| | | embodiments of the system 100 will require that the system 100 be |
| | | connected to a media player 848. For example, in some |
| | | embodiments, users 90 may connect a VRD apparatus 116 to a |
| | | BLU-RAY player in order to access the media content 840 on a BLU- |
| | | RAY disc. In other embodiments, the VRD apparatus 116 may |
| | | include stored media content 840 in the form a disc or computer |
| | | memory component. Non-integrated versions of the system 100 can |
| | | involve media players 848 connected to the system 100 through |
| | | wired and/or wireless means. |
| 850 | Interim Image | The image 880 displayed to user 90 is created by the modulation of |
| | | light 800 generated by one or light sources 210 in the illumination |
| | | assembly 200. The image 880 will typically be modified in certain |
| | | ways before it is made accessible to the user 90. Such earlier |
| | | versions of the image 880 can be referred to as an interim image |
| | | 850. |
| 880 | Image | A visual representation such as a picture or graphic. The system |
| | | 100 performs the function of displaying images 880 to one or more |
| | | users 90. During the processing performed by the system 100, light |
| | | 800 is modulated into an interim image 850, and subsequent |
| | | processing by the system 100 can modify that interim image 850 in |
| | | various ways. At the end of the process, with all of the modifications |
| | | to the interim image 850 being complete the then final version of the |
| | | interim image 850 is no longer a work in process, but an image 880 |
| | | that is displayed to the user 90. In the context of a video 890, each |
| | | image 880 can be referred to as a frame 882. |
| 881 | Stereoscopic | A dual set of two dimensional images 880 that collectively function |
| | Image | as a three dimensional image. |
| 882 | Frame | An image 880 that is a part of a video 890. |
| 890 | Video | In some instances, the image 880 displayed to the user 90 is part of |
| | | a sequence of images 880 can be referred to collectively as a video |
| | | 890. Video 890 is comprised of a sequence of static images 880 |
| | | representing snapshots displayed in rapid succession to each other. |
| | | Persistence of vision in the user 90 can be relied upon to create an |
| | | illusion of continuity, allowing a sequence of still images 880 to give |
| | | the impression of motion. The entertainment industry currently |
| | | relies primarily on frame rates between 24 FPS and 30 FPS, but the |
| | | system 100 can be implemented at faster as well as slower frame |
| | | rates. |
| 891 | Stereoscopic | A video 890 comprised of stereoscopic images 881. |
| | Video | |
| 900 | Method | A process for displaying an image 880 to a user 90. |
| 910 | Illumination | A process for generating light 800 for use by the system 100. The |
| | Method | illumination method 910 is a process performed by the illumination |
| | | assembly 200. |
| 920 | Imaging Method | A process for generating an interim image 850 from the light 800 |
| | | supplied by the illumination assembly 200. The imaging method 920 |
| | | can also involve making subsequent modifications to the interim |
| | | image 850. |
| 930 | Display Method | A process for making the image 880 available to users 90 using the |
| | | interim image 850 resulting from the imaging method 920. The |
| | | display method 930 can also include making modifications to the |
| | | interim image 850. |

1. An apparatus (110) that provides for enabling a user (90) within an environment (80) to access a media content unit (840), said apparatus (110) comprising:
a display (410) that provides for communicating a plurality of visual attributes (841) from the media content unit (840);
a speaker (560 that provides for communicating a plurality of acoustic attributes (842) from the media content unit (840);
a plurality of parameters (700) pertaining to the operation of the apparatus (110);
a plurality of configurations (705) comprised of at least a subset of said plurality of parameters (700), said plurality of configurations (705) including a first configuration (705) and a second configuration (705), wherein said second configuration (705) is less immersive than said first configuration (705);
a plurality of triggers (750) that provide for switching between said configurations (705), said plurality of triggers (750) including a first trigger (750) that provides for switching said apparatus (110) from said first configuration (705) to said second configuration (705).

2. The apparatus (110) of claim 1, wherein said apparatus (110) is a visor apparatus (115).

3. The apparatus (110) of claim 1, wherein said apparatus (110) is a VRD visor apparatus (116), and wherein said display (410) is a VRD eyepiece (418).

4. The apparatus (110) of claim 1, wherein said plurality of triggers (750) includes a user action (760) and an environmental stimulus (780).

5. The apparatus (110) of claim 1, wherein said plurality of triggers (750) includes a plurality of user actions (760), said plurality of user actions (760) including: (a) a user control (761); (b) an eye-movement gesture (762); (c) a kinetic gesture (763); (d) a pre-defined user gesture (764); (e) a peripheral device input (765); (f) a pre-defined voice command (768); and (g) a pre-defined schedule (767).

6. The apparatus (110) of claim 1, wherein said plurality of triggers (750) includes a plurality of environmental stimuli (780), said plurality of environmental stimuli (780) including: (a) an external sound (781); (b) an external light (782); (c) a detected location (783); (d) a detected proximity (784); (e) a detected motion (785); and a (f) an external communication (785).

7. The apparatus (110) of claim 1, wherein said plurality of parameters (700) includes: (a) a sound parameter (710); (b) a display parameter (720); (c) a progression parameter (730); and (d) a haptic parameter (740).

8. The apparatus (110) of claim 1, wherein said plurality of parameters (700) includes a plurality of sound parameters (710), said plurality of sound parameters (710) including: (a) a mute/off (711); (b) a reduced volume (712); (c) an oral alert (713); and (d) an external sound amplification (714).

9. The apparatus (110) of claim 1, wherein said plurality of parameters (700) includes a plurality of display parameters (720), said plurality of display parameters (720) including: (a) an off (721); (b) a dimmed (722); (c) an off/external view (723); (d) an on/augmented view (724); (e) a flash (725); (f) a written alerts (726); and (g) an increased brightness (727).

10. The apparatus (110) of claim 1, wherein said plurality of parameters (700) includes a plurality of progression parameters (730), said plurality of progression parameters (730) including: (a) a stop (731); (b) a pause (732); and (c) a timed pause (733).

11. The apparatus (110) of claim 1, wherein said apparatus (110) includes a plurality of sensors (650), said plurality of sensors (510) including an external camera (551) and a microphone (552).

12. The apparatus (110) of claim 1, wherein said apparatus (110) provides for operating in a plurality of operating modes (120), wherein said plurality of operating modes (120) include an immersion mode (121) and an augmentation mode (122).

13. The apparatus (110) of claim 12, wherein each said operating mode (120) includes more than one said plurality of configurations (705).

14. The apparatus (110) of claim 1, wherein said plurality of triggers (750) includes a first trigger (750, a second trigger (750), and a third trigger (750), wherein said third trigger (750) includes said first trigger (750) and said second trigger (750).

15. The apparatus (110) of claim 1, wherein said apparatus (110) includes an illumination assembly (200) for generating a plurality of light (800), an imaging assembly (300) for modulating said plurality of light (800) into an image (880) that is displayed to the user (90), a tracking assembly (500) for capturing an eye tracking attribute (530) from the user (90) while the user (90) is viewing an image (880) from the media content unit (840), and an augmentation assembly (600).

16. The apparatus (110) of claim 1, wherein said apparatus (110) further includes a partially transparent plate (430), and wherein said tracking assembly (500) and said augmentation assembly (500) utilize said partially transparent plate (430).

17. A system (100) that provides for enabling a user (90) within an environment (80) to access a media content unit (840), said system (100) comprising:
a visor apparatus (115) that provides for being worn by the user (90), wherein said visor apparatus (115) provides for enabling the user (90) to receive a plurality of visual attributes (841) and a plurality of acoustic attributes (842) from the media content unit (840);
a plurality of parameters (700) that pertain to the operating of said visor apparatus (115);
a plurality of configurations (705) defined with respect to at least a subset of said plurality of parameters (700), said plurality of configurations (705) including a first configuration (705) and a second configuration (705), wherein said second configuration (705) is less immersive than said first configuration (705);
a plurality of triggers (750) associated with said plurality of configurations (705), said plurality of triggers (750) including a first trigger (750) wherein said first trigger (750) automatically changes said configuration (705) for said apparatus (110) from said first configuration (705) to said second configuration (705).

19. The system (100) of claim 18, wherein said plurality of triggers (750) include a plurality of environmental stimuli (780).

20. A method (900) for a user (90) to engage in a media experience (840) through use of a visor apparatus (115), wherein the visor apparatus (115) includes a plurality of parameters (700), said method (900) comprising:
initiate (910) a media experience (840);
detect (920) a trigger (750) while the user (90) is engaged in the media experience (840), wherein said trigger (750) is not a user control (761);
change (930) from a first configuration (705) of a first subset of parameters (700) to a second configuration (705) of a second subset of parameters (700), wherein said second configuration (705) is less immersive than said first configuration (705).
